(19) United States
(12) Patent Application Publication
(10) Pub. No.: US 2013/0132058 A1
(43) Pub. Date: May 23, 2013

(54) CREATING AND MANAGING VIRTUAL AREAS

(71) Applicant: Social Communications Company, Eugene, OR (US)

(72) Inventors: Robert J. Butler, Coralville, IA (US); David Van Wie, Eugene, OR (US)

(73) Assignee: Social Communications Company, Eugene, OR (US)

(21) Appl. No.: 13/680,463

(22) Filed: Nov. 19, 2012

Related U.S. Application Data
(60) Provisional application No. 61/563,088, filed on Nov. 23, 2011.

(51) Int. Cl. H04L 29/06; G06F 17/00

(52) U.S. Cl. CPC H04L 65/1003; G06F 17/00
USPC 703/21

(57) ABSTRACT

Systems and methods of managing communications in a virtual area are described. Examples of the systems and methods provide services for creating highly customizable virtual area applications that support realtime virtual area communications. In some examples, these services manage communications between network nodes that are linked to a virtual area according to rules embodied in a virtual area application defining the virtual area. Examples of the systems and methods provide a generic framework for transforming a designer's specification of a virtual area into instructions that dynamically configure service functionality for acting on messages that are received from network nodes in connection with the virtual area.

### CROSS-REFERENCE TO RELATED APPLICATIONS

Under 35 U.S.C. §119(e), this application claims the benefit of U.S. Provisional Application No. 61/563,088, filed Nov. 23, 2011, the entirety of which is incorporated herein by reference.

This application relates to the following co-pending patent applications, the entirety of each of which is incorporated herein by reference: U.S. patent application Ser. No. 12/825,512, filed Jun. 29, 2010; U.S. patent application Ser. No. 12/354,709, filed Jan. 15, 2009; U.S. patent application Ser. No. 12/418,270, filed Apr. 3, 2009; U.S. patent application Ser. No. 13/165,729, filed Jun. 21, 2011; U.S. Provisional Patent Application No. 61/373,914, filed Aug. 16, 2010; U.S. Provisional Patent Application No. 61/444,989, filed Feb. 21, 2011; and U.S. Provisional Patent Application No. 61/535,910, filed Sep. 16, 2011.

### BACKGROUND

When face-to-face communications are not practical, people often rely on one or more technological solutions to meet their communications needs. Traditional telephony systems enable voice communications between callers. Instant messaging (also referred to as “chat”) communications systems enable users to communicate text messages in real time through instant message computer clients that are interconnected by an instant message server. Some instant messaging systems and interactive virtual reality communications systems allow users to be represented by user-controllable graphical objects (referred to as “avatars”). What are needed are improved systems and methods for realtime network communications.

### DESCRIPTION OF DRAWINGS

FIG. 1 is a diagrammatic view of an example of a network communications environment that includes first and second client network nodes and a virtual area platform that includes at least one server network node.

FIG. 2A is a diagrammatic view of an example of a graphical user interface showing a perspective view of a virtual area that includes zones that are associated with respective real-time data stream switching rules.

FIG. 2B is a diagrammatic plan-view of the virtual area shown in FIG. 2A that is populated with four avatar objects.

FIG. 3 is a diagrammatic view of an example of a server node administering network node communications in connection with a virtual area.

FIG. 4 is a flow diagram of an example of network node communication management method.

FIG. 5 is a diagrammatic view of an example of a message handling service configuration created by an example of an area service according to a virtual area application that is derived from a virtual area specification.

FIG. 6 is a diagrammatic view of an example of a message handling service architecture.

FIG. 7 is a diagrammatic plan view of an example of a spatial layout of location and governance zones.

FIG. 8 is a diagrammatic view of an example of the network communications environment of FIG. 1 that shows an exemplary set of network connections and sessions between the network nodes.

FIG. 9 is a diagrammatic view of an example of a client network node.

FIG. 10 is a diagrammatic view of an example of the network communication environment of FIG. 1 in which client and server network nodes communicate on various channels in the respective sessions that are established between the network nodes.

FIG. 11 is a diagrammatic view of an example of a message handling service architecture.

FIG. 12 is a block diagram of an example of a network communications environment that includes a first client network node, a second client network node, a PSTN device, and a virtual environment creator.

### DETAILED DESCRIPTION

In the following description, like reference numbers are used to identify like elements. Furthermore, the drawings are intended to illustrate major features of examples in a diagrammatic manner. The drawings are not intended to depict every feature of actual examples nor relative dimensions of the depicted elements, and are not drawn to scale.

### I. DEFINIITON OF TERMS

A “communicant” is a person who communicates or otherwise interacts with other persons over one or more network connections, where the communication or interaction may or may not occur in the context of a virtual area. A “user” is a communicant who is operating a particular network node that defines a particular perspective for descriptive purposes.

A “computer” is any machine, device, or apparatus that processes data according to computer-readable instructions that are stored on a computer-readable medium either temporarily or permanently. A “computer operating system” is a software component of a computer system that manages and coordinates the performance of tasks and the sharing of computing and hardware resources. A “software application” (also referred to as software, an application, computer software, a computer application, a program, and a computer program) is a set of instructions that a computer can interpret and execute to perform one or more specific tasks. A “data file” is a block of information that durably stores data for use by a software application.

The term “computer-readable medium” refers to any tangible, non-transitory medium capable storing information (e.g., instructions and data) that is readable by a machine (e.g., a computer). Storage devices suitable for tangibly embodying such information include, but are not limited to, all forms of physical, non-transitory computer-readable memory, including, for example, semiconductor memory devices, such as random access memory (RAM), EPROM, EEPROM, and Flash memory devices, magnetic disks such as internal hard disks and removable hard disks, magneto-optical disks, DVD-ROM/RAM, and CD-ROM/RAM.

A “data sink” (referred to herein simply as a “sink”) is any of a device (e.g., a computer), part of a device, or software that receives data.

A “data source” (referred to herein simply as a “source”) is any of a device (e.g., a computer), part of a device, or software that originates data.

A “network node” (also referred to simply as a “node”) is a junction or connection point in a communications network. Examples of network nodes include, but are not limited to, a terminal, a computer, and a network switch. A “server” network node is a host computer on a network that responds to requests for information or service. A “client network node” is a computer on a network that requests information or service from a server.

A Uniform Resource Identifier (URI) is a string of characters that identifies a network resource.

A “network resource” is anything that can be identified by a uniform resource identifier (URI) and accessed over a network, including an electronic document, an image, a source of information, a service, operators and operands of a mathematical equation, classes, properties, numeric values, and a collection of other resources.

A “network connection” is a link between two communicating network nodes. A “connection handle” is a pointer or identifier (e.g., a uniform resource identifier (URI)) that can be used to establish a network connection with a network resource. A “network communication” can include any type of information (e.g., text, voice, audio, video, electronic mail message, data file, motion data stream, and data packet) that is transmitted or otherwise conveyed from one network node to another network node over a network connection.

A “communicant interaction” is any type of direct or indirect action or influence between a communicant and another network entity, which may include for example another communicant, a virtual area, or a network service. Examples of types of communicant interactions include communicants communicating with each other in realtime, a communicant entering a virtual area, and a communicant requesting access to a resource from a network service.

“Presence” refers to the ability and willingness of a networked entity (e.g., a communicant, service, or device) to communicate, where such willingness affects the ability to detect and obtain information about the state of the entity on a network and the ability to connect to the entity.

A “realtime data stream” is data that is structured and processed in a continuous flow and is designed to be received with no delay or only imperceptible delay. Realtime data streams include digital representations of voice, video, user movements, facial expressions and other physical phenomena, as well as data within the computing environment that may benefit from rapid transmission, rapid execution, or both rapid transmission and rapid execution, including for example, avatar movement instructions, text chat, realtime data feeds (e.g., sensor data, machine control instructions, transaction streams and stock quote information feeds), screen shares, and file transfers.

A “virtual area” (also referred to as an “area” or a “place”) is a representation of a computer-managed space or scene. Virtual areas typically are one-dimensional, two-dimensional, or three-dimensional representations; although in some examples a virtual area may correspond to a single point. Oftentimes, a virtual area is designed to simulate a physical, real-world space. For example, using a traditional computer monitor, a virtual area may be visualized as a two-dimensional graphic of a three-dimensional computer-generated space. However, virtual areas do not require an associated visualization. A virtual area typically refers to an instance of a virtual area schema, where the schema defines the structure and contents of a virtual area in terms of variables and the instance defines the structure and contents of a virtual area in terms of values that have been resolved from a particular context.

A “virtual area communications application” is a client communications application that integrates realtime audio communications (and potentially other realtime communications, e.g., video, chat, and realtime other data stream) with visual presentations of interactions in a virtual area.

A “virtual environment” is a representation of a computer-managed space that includes at least one virtual area and supports realtime communications between communicants.

A “zone” is a region of a virtual area that is associated with at least one switching rule or governance rule. A “switching rule” is an instruction that specifies a connection or disconnection of one or more realtime data sources and one or more realtime data sinks subject to one or more conditions precedent. A switching rule controls switching (e.g., routing, connecting, and disconnecting) of realtime data streams between network nodes communicating in the context of a virtual area. A governance rule controls a communicant's access to a resource (e.g., an area, a region of an area, or the contents of that area or region), the scope of that access, and follow-on consequences of that access (e.g., a requirement that audit records relating to that access must be recorded). A “location zone” is a zone that is associated with a respective visualization.

A “position” in a virtual area refers to a location of a point or an area or a volume in the virtual area. A point typically is represented by a single set of one-dimensional, two-dimensional, or three-dimensional coordinates (e.g., x, y, z) that define a spot in the virtual area. An area typically is represented by the three-dimensional coordinates of three or more coplanar vertices that define a boundary of a closed two-dimensional shape in the virtual area. A volume typically is represented by the three-dimensional coordinates of four or more non-coplanar vertices that define a closed boundary of a three-dimensional shape in the virtual area.

A “spatial state” is an attribute that describes where a user has presence in a virtual area. The spatial state attribute typically has a respective value (e.g., a zone_ID value) for each of the zones in which the user has presence.

A “communication state” is an attribute that describes a state of a respective communication channel over which a respective one of the communicants is configured to communicate.

A “connection rule” designates at least one of a virtual area and a connection target, and includes an optional set of one or more connection conditions that guides the behavior of a suitably configured software application or service in initiating network connections. A “connection target” refers to an identifier or connection handle (e.g., a uniform resource identifier (URI)) that can be used to establish a network connection with a communicant, resource, or service on a network node. A “connection condition” specifies one or more parameters that influence the establishing of a network connection, the managing of a network connection, or the processing of data transferred across a network connection. For example, a connection condition may describe a predicate on the operating environment that should be satisfied before a network connection is attempted or established.

An Extensible Markup Language (XML) is a text-based format for representing structured information. A specification of an XML standard is published by W3C at http://www.w3.org/TR/xml/.

As used herein, the term “includes” means includes but not limited to, the term “including” means including but not limited to. The term “based on” means based at least in part on.

### II. VIRTUAL AREA PLATFORM

The examples that are described herein provide a virtual area platform that includes services for creating highly customizable virtual area applications that support realtime virtual area communications. In some examples, these services handle the complex tasks of managing communications between network nodes that are linked to a virtual area according to rules embodied in a virtual area application defining the virtual area. Examples of the virtual area platform provide a generic framework for transforming a designer's specification of a virtual area (e.g., an XML document) into instructions that dynamically configure platform and application-specific services and other functionality for acting on messages that are received from network nodes in connection with the virtual area. Examples of the virtual area platform provide an extensible environment that supports custom data types and services (including replacing existing platform data types). In these ways, examples of the virtual area platform encourage the development of a wide variety of virtual area applications, including virtual area applications that implement spatial rules for one or more synchronous conferencing services (e.g., instant messaging, such as text chat, audio conferencing, video conferencing, application sharing, and file sharing). Examples of the virtual area platform enable virtual area designers to focus on developing high-level communications functionality of a virtual area instead of low-level plumbing code, while maintaining control over the communication and interaction environment created by the virtual area.

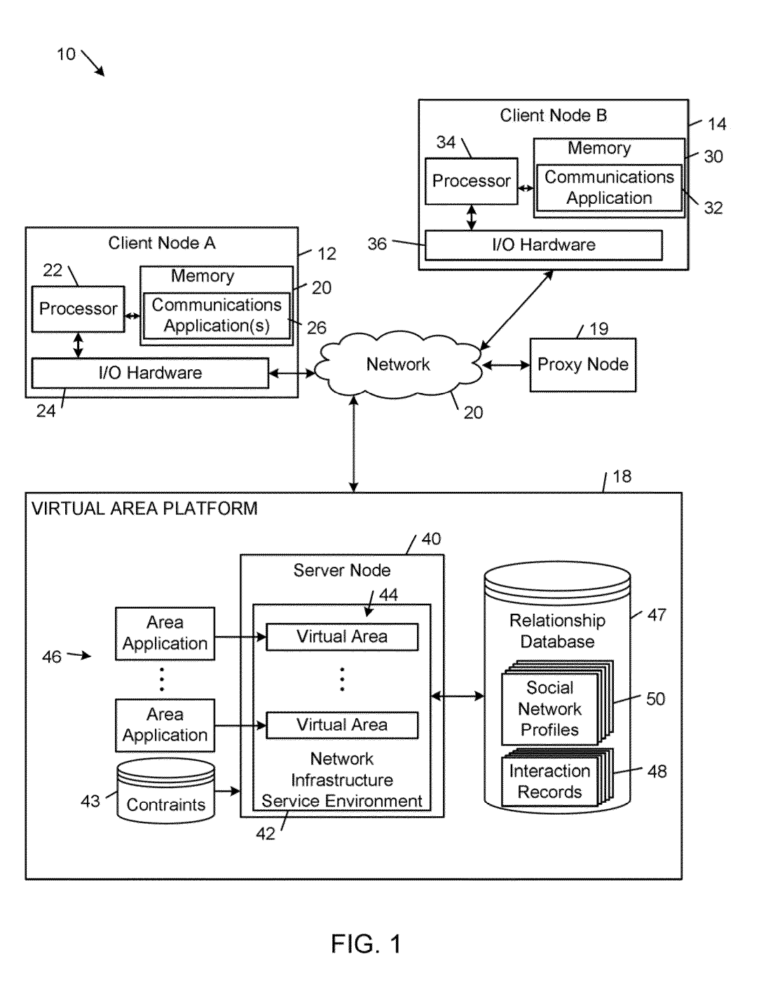

FIG. 1 shows an example of a network communications environment 10 that includes a first client network node 12 (Client Node A), a second client network node 14 (Client Network Node B), a virtual area platform 18 and an optional proxy node 19 that are interconnected by a network 20. The network 20 may include one or more of any of a local area network (LAN), a metropolitan area network (MAN), and a wide area network (WAN) (e.g., the internet). The network 20 typically includes a number of different computing platforms and transport facilities that support the transmission of a wide variety of different media types (e.g., text, voice, audio, video, and other data) between network nodes.

The first client network node 12 includes a computer-readable medium 22 (or “memory”), a processor 24, and input/output (I/O) hardware 26 (including a display). The processor 24 executes at least one virtual area communications application 26 that is stored in the memory 22. The second client network node 14 typically is configured in substantially the same general way as the first client network node 12, with a computer-readable medium 30 storing at least one virtual area communications application 32, a processor 34, and input/output (I/O) hardware 36 (including a display).

Each of the network nodes 12, 14 has a respective set of one or more sources and an exemplary set of one or more sinks. Each source is a device or component that originates data of a particular data stream content type and each sink is a device or component that receives data of a particular data stream content type. A source and a sink of the same data stream content type are referred to herein as being “complementary.” Exemplary sources include an audio source (e.g., an audio capture device, such as a microphone), a video source (e.g., a video capture device, such as a video camera), a chat source (e.g., a text capture device, such as a keyboard), a motion data source (e.g., a pointing device, such as a computer mouse), and other sources (e.g., file sharing source or a source of a customized real-time data stream). Exemplary sinks include an audio sink (e.g., an audio rendering device, such as a speaker or headphones), a video sink (e.g., a video rendering device, such as a display monitor), a chat sink (e.g., a text rendering device, such as a display monitor), a motion data sink (e.g., a movement rendering device, such as a display monitor), and other sinks (e.g., a printer for printing shared files, a device for rendering real-time data streams different from those already described, or software that processes real-time streams for analysis or customized display). Each source has an active state in which the source is available for originating data and an inactive state in which the source is not available for originating data. Likewise, each sink has an active state in which the sink is available for receiving data and an inactive state in which the sink is not available for receiving data. The communicants operating the client nodes 12, 14 typically can control the states of the sources and sinks using controls provided by the communications applications 26, 32. For example, in some examples, the communications applications 26, 32 provide user controls for turning on/off the local microphones and the local speakers (e.g., headsets) on the client network nodes 12, 14.

In the illustrated example, the virtual area platform 18 includes at least one server network node 40 that provides a network infrastructure service environment 42 that manages sessions of the first and second client nodes 12, 14 in one or more virtual areas 44 in accordance with respective virtual area applications 46. The network infrastructure service environment 42 typically includes one or more network infrastructure services that cooperate with the communications applications 26, 32 in the process of establishing and administering network connections between the client nodes 12, 14 and other network nodes. Among the network infrastructure services that are included in the example of the network infrastructure service environment 42 are an account service, a security service, an area service, a rendezvous service, an interaction service, and a capabilities engine. Examples of an account service, a security service, an area service, a rendezvous service, an interaction service, and a capabilities engine are described in U.S. Provisional Patent Application No. 61/535,910, filed Sep. 16, 2011.

In some examples, the network infrastructure service environment 42 maintains a relationship database 47 that contains the records 48 of interactions between communicants and social network profiles 50 that are associated with respective communicants. Each interaction record describes the context of an interaction between a pair of communicants. For example, in some examples, an interaction record contains an identifier for each of the communicants, an identifier for the place of interaction (e.g., a virtual area instance), a description of the hierarchy of the interaction place (e.g., a description of how the interaction room relates to a larger area), start and end times of the interaction, and a list of all files and other data streams that are shared or recorded during the interaction. Thus, for each realtime interaction, the network infrastructure service environment 42 tracks when it occurred, where it occurred, and what happened during the interaction in terms of communicants involved (e.g., entering and exiting), objects that are activated/deactivated, and the files that were shared. Each social network profile 50 typically includes: identity characteristics (e.g., name, age, gender, and geographic location information such as postal mailing address) that describe a respective communicant or a persona that is assumed by the communicant; explicit relationship information that is declared by the communicant; and relationship information that is inferred from the communicant's interactions in the network communication environment 10.

The communications applications 26, 32, the area applications 46, and the network infrastructure service environment 42 together provide a platform that administers the realtime connections with network nodes in an instance of a virtual area subject to a set of constraints 43 (e.g., capabilities and other types of permissions, rules, and preferences). Each of the virtual area applications 46 is hosted by a respective one of the virtual areas 44 and includes a description of the respective virtual area 44. Communicants respectively operating the client nodes 12, 14 connect to the virtual areas 44 through the virtual area communications applications 26, 32.

The communications applications 26, 32 typically present respective views of the virtual areas 44 in accordance with data received from the network infrastructure service environment 42. The communications applications 26, 32 also provide respective interfaces for receiving commands from the communicants and providing an interface that enhances the realtime communications between the communicants. The communicants typically are represented in the virtual areas 44 by respective avatars (e.g., sprites), which typically move about the virtual areas 44 in response to commands that are input by the communicants at their respective network nodes. In some examples, the communications applications 26, 32 establish realtime data stream connections between the first and second client network nodes 12, 14 and other network nodes connected to the virtual area 44 based on the positions of the communicants' avatars in the virtual areas 44.

A virtual area 44 may correspond to an abstract (non-geometric) virtual area that is defined with respect to abstract coordinates, or a visual virtual area that is defined with respect to one-, two- or three-dimensional geometric coordinates. Abstract virtual areas may or may not be associated with respective visualizations, whereas visual virtual areas are associated with respective visualizations.

In some of the examples that are described herein, the virtual areas are visual virtual areas of the type disclosed in U.S. Pat. Nos. 7,769,806 and 7,844,724. These visual virtual areas include physical geometry and collision geometry. The physical geometry describes the shape of the virtual area. The physical geometry typically is formed from surfaces of triangles, quadrilaterals, or polygons. Colors and textures are mapped onto the physical geometry to create a more realistic appearance for the virtual area. Lighting effects may be painted onto the visual geometry and the texture, color, or intensity near the lighting effects may be modified. The collision geometry describes invisible surfaces that determine the ways in which objects can move in the virtual area. The collision geometry may coincide with the visual geometry, correspond to a simpler approximation of the visual geometry, or relate to application-specific requirements of a virtual area designer.

Some examples of the virtual area platform enable software application designers to define the semantics of position in an abstract virtual area (e.g., a software application or a computer data file). Through associations with respective connection rules, these position definitions can be used, for example, to drive connections to virtual areas, entries into virtual areas, connections to communicants and other sources or sinks of realtime data streams, and determinations of presence data relating to communicants, network resources, and network services. Additional details regarding systems and methods of defining the semantics of position in abstract virtual areas are described in U.S. application Ser. No. 12/631,008, which was filed on Dec. 4, 2009.

A virtual area typically includes one or more zones. A zone may be a rendered spatial extent, a set of rules applied to a spatial extent, or both. Zones may be arranged hierarchically in a virtual area, with an outermost zone (referred to herein as the “Global Governance Zone”) enclosing all other zones in the virtual area. Within the Global Governance Zone, there can be location zones (e.g., rooms of a virtual area) or smaller governance zones that enclose a group of location zones and provide regions of governance on the map. A zone definition typically also includes one or more channel definitions that describe how to create respective channels in the zone and specify the information about the channel that is published to a client network node that becomes present in the zone. A channel is always uniquely defined point-to-point and is unique to a session and an area application.

Examples of the types of rules that may be associated with a zone include switching rules, governance rules, and permission rules.

The switching rules govern realtime stream connections between network nodes that are linked to the virtual area (e.g., network nodes that are associated with objects, such as avatars, in the virtual area). The switching rules typically include a description of conditions for connecting sources and sinks of realtime data streams in terms of positions in the virtual area. Each rule typically includes attributes that define the realtime data stream type to which the rule applies and the location or locations in the virtual area where the rule applies. In some examples, each of the rules optionally may include one or more attributes that specify a required role of the source, a required role of the sink, a priority level of the stream, and a requested stream handling topology. In some examples, if there are no explicit switching rules defined for a particular part of the virtual area, one or more implicit or default switching rules may apply to that part of the virtual area. One exemplary default switching rule is a rule that connects every source to every compatible sink within an area, subject to policy rules. Policy rules may apply globally to all connections between the area clients or only to respective connections with individual area clients. An example of a policy rule is a proximity policy rule that only allows connections of sources with compatible sinks that are associated with respective objects that are within a prescribed distance (or radius) of each other in the virtual area. The network connections between network nodes may be arranged in a variety of different stream handling topologies, including a peer-to-peer architecture, a server-mediated architecture, and hybrid architectures that combine aspects of peer-to-peer and server-mediated architectures. In some examples, the switching rules dictate how local connection processes executing on each of the network nodes establishes communications with the other network nodes based on the locations of the associated objects in the zones of the virtual area. A switching rule also may define a direct connection between network nodes or an indirect connection through an intermediate network node (e.g., the proxy node 19; see FIG. 1).

The governance rules control who has access to resources (e.g., the virtual area itself, regions with the virtual area, and objects within the virtual area), who has access to data (e.g., data streams and other content) that is associated with the virtual area, what is the scope of that access to the data associated the virtual area (e.g., what can a user do with the data), and what are the follow-on consequences of accessing that data (e.g., record keeping, such as audit logs, and payment requirements). In some examples, an entire virtual area or a zone of the virtual area is associated with a “governance mesh” that enables a software application developer to associate governance rules with a virtual area or a zone of a virtual area. This avoids the need for the creation of individual permissions for every file in a virtual area and avoids the need to deal with the complexity that potentially could arise when there is a need to treat the same document differently depending on the context.

A permission rule defines a respective capability requirement (e.g., for a respective action, behavior, or state) in terms of one or more capabilities, attributes, and settings, which may be persistent or transient. Examples of permission rules include: a rule that conditions a communicant's ability to enter a target zone on the communicant having a CanEnterZone capability for the target zone; a rule that conditions the ability of a grantee communicant to open a target door of a target room on the grantee communicant having a CanOpenDoor capability for the target room; and a rule that conditions the transmission of a message describing the state of a particular communicant's avatar in a zone to a recipient having a CanSeeState capability for the particular communicant in the zone. A capability provides permission for a client to perform some action within the application. For example, a client may be granted the capability “CanEnterZone” for a specific zone within a virtual area that has been defined with that capability requirement. The client that has the capability can enter the zone, whereas a client without the capability would have their RDS state change rejected when they tried to enter the zone. Examples of capabilities systems for administering permission rules are described in U.S. Provisional Patent Application No. 61/535,910, filed Sep. 16, 2011.

The virtual area platform enables a wide variety of highly customizable virtual area applications to be created. Examples of such applications include virtual area applications for creating a virtual office, a virtual personal space, a virtual art gallery, a virtual concert hall, a virtual auditorium, a virtual conference room, and a virtual club house.

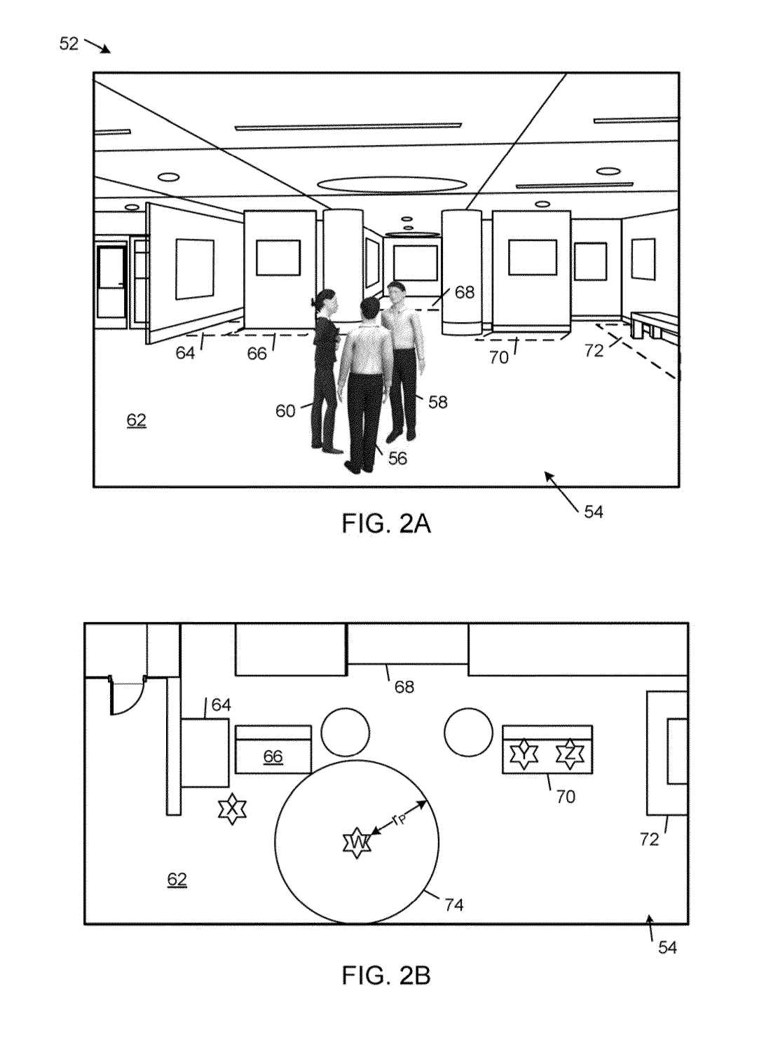

FIG. 2A shows an example of a graphical user interface 52 that presents a two-dimensional view of a visual virtual art gallery area 54. Communicants are represented in the virtual area 54 by respective avatars 56, 58, 60, each of which may have a respective role (e.g., a curator, an artist, and a visitor) in the virtual area 66. The virtual area 54 includes zones 62, 64, 66, 68, 70, 72. (During a typical communication session, the dashed lines demarcating the zones 62-72 in FIG. 2 are not visible to the communicants although there may be visual cues associated with such zone boundaries.) In some examples, each of the zones 62-72 has a respective zone boundary that is associated with a respective <zone_mesh> tag that has a number of attributes (e.g. <zone>, <stream> and <sink> tags) in accordance with the COLLADA Streams Reference specification described in U.S. Pat. Nos. 7,769,806 and 7,844,724.

FIG. 2B shows a plan view of the virtual art gallery area 54 at a time when it is populated with four avatars W, X, Y, and, Z. The avatars W and X are positioned in the zone 62 and the avatars Y and Z are positioned in the zone 70. For the purpose of this illustrative example:
each of the avatars W-Z is associated with voice, video, and chat source types and sink types;
the switching rules for zone 62 specify that
   each voice source that is associated with an avatar within the zone 62 is to be connected to every voice sink within the zone 62,
   each video source that is associated with an avatar within the zone 62 is to be connected to every video sink within the zone 62, and
   each chat source that is associated with an avatar within the zone 62 is to be connected to every chat sink within the zone 62;
the switching rules for zone 70 specifies only that that each voice source that is associated with an avatar within the zone 70 is to be connected to every voice sink within the zone 70; and
the server node executes a message handling service for the virtual area 54 that implements, on top of the zone switching rules, a proximity policy rule that only allows connections of sources with compatible sinks that are associated with respective objects that are within a prescribed distance (or radius), r_{P}, of each other in the virtual area.

In this example, the switching rules and the proximity policy rule provide respective switching conditions that determine how the connections between the avatars W, X, Y, and Z are established.

In operation, the message handling service for the virtual area 54 would send instructions for the area client node that is associated with avatar W to connect to the real-time voice, video, and chat streams that are sourced from the area client node that is associated with avatar X whenever avatar X is positioned within a proximity zone 74, which defined by the prescribed distance r_{P}, around avatar W. Likewise, the message handling service would send instructions for the area client node that is associated with avatar X to connect to the real-time voice, video, and chat streams that are sourced from the area client node that is associated with avatar W whenever avatar W is positioned within the prescribed distance r_{P} of avatar X. Since avatar X currently is outside the proximity zone 74 of avatar A, and vice versa, the nodes associated with avatars W and X would not be connected to each other in the current exemplary state shown in FIG. 2B.

Since the zone 70 only allows voice connections, the message handling service would send instructions for the area client node that is associated with avatar Y to connect to only the real-time voice stream that is sourced from the area client node that is associated with avatar Z (assuming the proximity condition specified in the proximity policy rule is satisfied). Similarly, the message handling service would send instructions for the area client node that is associated with avatar Z to connect to only the real-time voice stream that is sourced from the area client node that is associated with avatar Y (assuming the proximity condition specified in the proximity policy rule is satisfied).

Since the switching rules for zones 62 and 70 do not allow connections between zones 62 and 70, the sources and sinks that are associated with avatars W and X would not be connected to any of the sources and sinks that are associated with avatars Y and Z, even if the proximity condition specified in the proximity policy rule is satisfied.

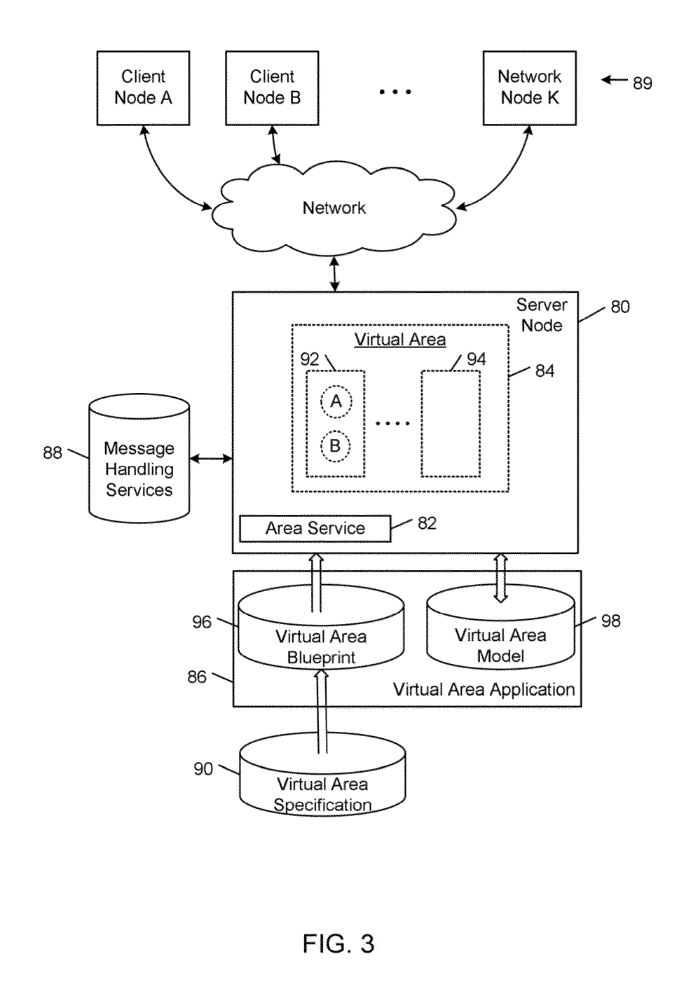

FIG. 3 shows an example of a server node 80 that provides an area service 82 that administers network node communications in connection with a virtual area 84 in accordance with a virtual area application 86. The virtual area application 86 specifies the types of data streams that are communicable between network nodes that are associated with respective ones of the one or more zones of the virtual area, encapsulates a set of rules that define how the message handling services 88 respond to messages and events received from client and other network nodes 89, and contains information describing the current state of the virtual area and the objects within the virtual area. The area service 82 executes the virtual area application 86 to create the virtual area 84, which hosts the virtual area application 86.

The area service 82 creates the virtual area application 86 from a virtual area specification 90. The virtual area specification 90 typically defines one or more zones 92, 94 of the virtual area 84, specifies a message processing protocol for each of one or more message types, specifies validation rules for validating messages of respective message types in connection with respective ones of the one or more zones, and specifies follow-on rules for acting on messages of respective message types. In some examples, the virtual area specification 90 is an XML document that references service features and objects that are provided by the virtual area platform or a third party provider. The area service 82 parses the virtual area specification 90 into a parsed or compiled binary format 96 (referred to herein as a “virtual area blueprint”).

The area service 82 also maintains a virtual area model 98 that includes a description of the current global state of the virtual area and the current states of the respective sessions of the network nodes 89 with the server node 80. The area service 82 determines the initial configuration and states of the virtual area 84, and then updates the virtual area model 98 to reflect the changes that are made by the area service 82 to the configuration and states of the virtual area 84 and the network node sessions in the course of applying the rules embodied in the virtual area application 86 to messages and other events that are received from the network nodes 89 in connection with the virtual area 84. In some of these examples, the global state information includes a list of all the objects that are in the virtual area, including objects A and B that are associated with respective sessions of Client Node A and Client Node B in the virtual area 84, and the respective spatial locations (e.g., the spatial states) of those objects in the zones 92, 94 of the virtual area 84.

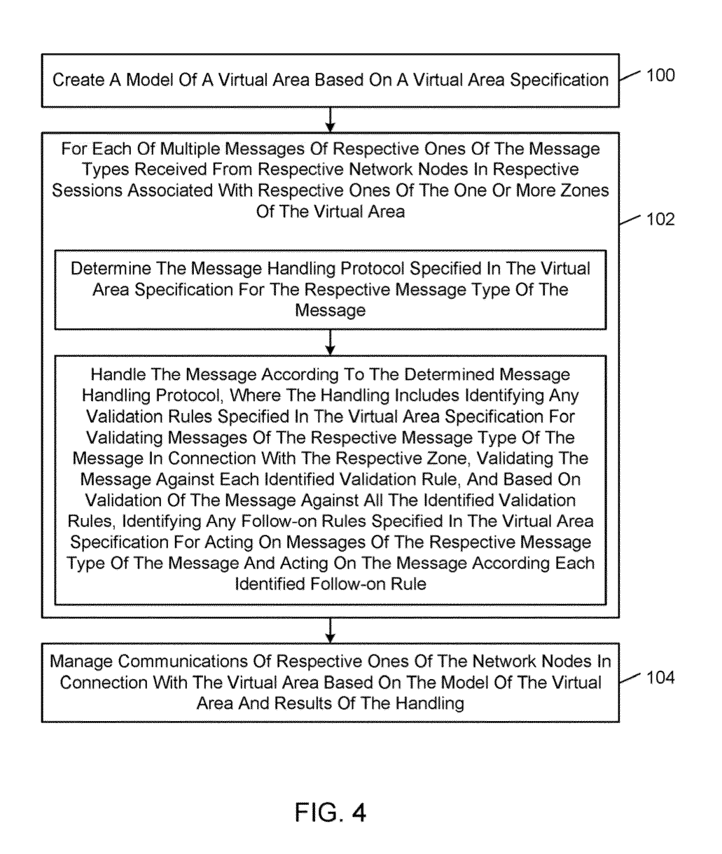

FIG. 4 shows an example of network node communication management method that is performed by an example of the server node 80.

In accordance with the method of FIG. 4, the server node 80 creates the model 98 of the virtual area 84 based on the virtual area specification 90 (FIG. 4, block 100). In this process, the area service 82 running on the server node 80 parses the virtual area specification 90 to produce the virtual area blueprint 96 and executes the virtual area blueprint 96 to create the virtual area application 86. The area service 82 determines an initial configuration for the virtual area model that reflects the initial state of the virtual area 84 and any network node sessions that are associated with the virtual area 84.

For each of multiple messages of respective ones of the message types received from respective network nodes in respective sessions associated with respective ones of the one or more zones of the virtual area, the server node 80 determines the message handling protocol that is specified in the virtual area specification 90 for the respective message type of the message, and handles the message according to the determined message handling protocol (FIG. 4, block 102). The message handling process includes identifying any validation rules specified in the virtual area specification 90 for validating messages of the respective message type of the message in connection with the respective zone, validating the message against each identified validation rule, and based on validation of the message against all the identified validation rules, identifying any follow-on rules specified in the virtual area specification for acting on messages of the respective message type of the message and acting on the message according each identified follow-on rule.

The server node 80 manages communications of respective ones of the network nodes in connection with the virtual area 84 based on the virtual area model 98 and results of the handling (FIG. 4, block 104).

The virtual area application 86 is an event-driven rules engine that embodies characteristics and rules that are specified by the area designer in the virtual area specification 90. In contrast to traditional service application programs, the service configuration functionality that the virtual area application 86 provides changes dynamically in response to messages without having to be recompiled. Based on the virtual area application 86, the area service 82 dynamically assembles generic and/or application-specific message handling services 88 into different service configurations that act on different types of messages that are received by the server node 80 from the network nodes 89.

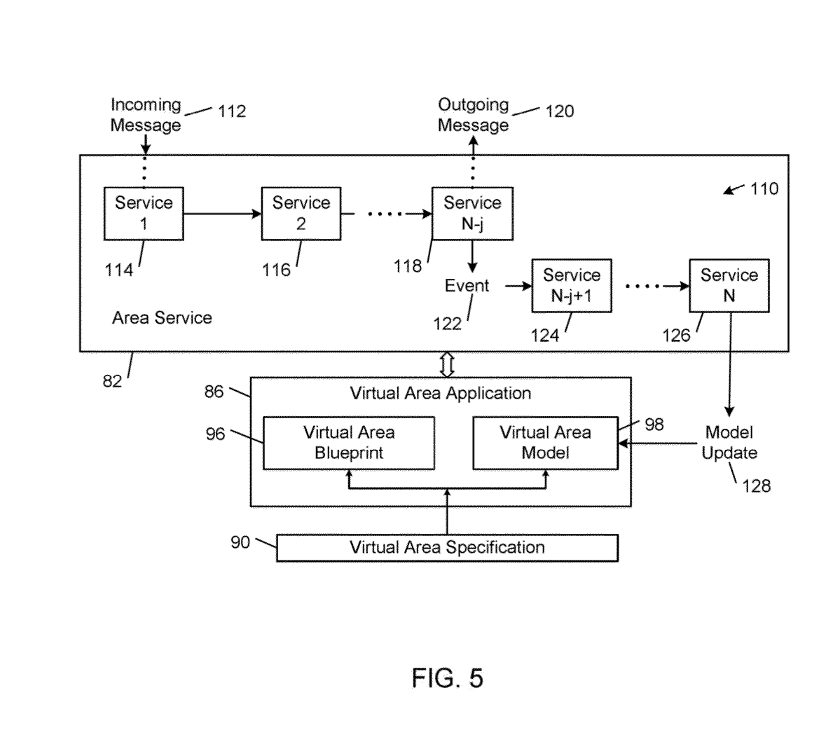

FIG. 5 shows an example of a message handling service configuration 110 that is created by the area service 82 according to an example of the virtual area application 86 (see FIG. 3). In response to receipt of an incoming message 112 of a particular message type, the area service 82 determines the message handling protocol that is specified in the virtual area specification 90 for the respective message type of the message 112. In this process, the area service 82 typically determines from the virtual area application 86 one or more message handling services 114, 116, . . . , 118 that are designated for handling messages of the particular message type. The area service 82 applies the determined message handling services 114, 116, . . . , 118 to the incoming message 112 in a specific order, which may be specified by the determined message handling protocol in the virtual area application 86. The message handling services 114, 116, . . . , 118 may perform a wide variety of operations, transformations, or rule-based actions on information contained in or derived from the message 112. The information may be processed through the message handling services 114, 116, . . . , 118 serially or in parallel. In the illustrated example, the application of the message handling service 118 to the message 112 triggers the transmission of an outgoing message 120 and an event 122. The outgoing message 120 is transmitted from a network node (e.g., the server node 80) to another network node (e.g., the network node that transmitted the incoming message 112). In this example, the event 122 causes the area service 82 to call additional message handling services services 124, . . . , 126, which may be applied to the incoming message 112, information derived from the incoming message 112, or other information. The application of the message handling service 126 triggers a model update 128 that the area service 82 applies to the virtual area model 98.

Examples of the virtual area specification 90 can program the area service 82 to dynamically configure message handling services into service configurations that provide a wide variety of message and event driven functions that support realtime interaction, signaling, multichannel data transmission, and synchronization between a collection of dynamic nodes that are associated with the virtual area, as well as mediation functions that validate changes and propagate validated changes to create a consistent communications environment across all the nodes associated with the virtual area. Examples of such functions include: message handling functions for processing, routing, and acting on platform and application-specific message types; validation functions that validate proposed state changes to ensure compliance with various application, governance, and service rules (e.g., functions that ensure that nodes cannot manipulate the same data in inconsistent ways); switching functions that switch connections between the sources and sinks of network nodes according to position in a virtual area; area modification functions that enable nodes to change properties of a virtual area; and dynamic response functions that automatically instantiate a virtual area and potentially invite members of the virtual area to enter the virtual area in response to an event.

In some examples, the virtual area specification 90 specifies an area entry message handling protocol for area entry messages. For an area entry message from a particular one of the network nodes requesting entry into the virtual area, the area service 82 determines the area entry message handling protocol specified in the virtual area specification, and handles the area entry message according to the determined area entry message handling protocol. In this process, the area service 82 ascertains one or more changes to state information (e.g., one or more changes to a state attribute of the particular network node) in the virtual area model 98 to reflect entry of the particular network node into the virtual area, and modifies the virtual area model 98 based on the one or more ascertained changes to produce a current model of the virtual area. The area service 82 then manages communications of respective ones of the network nodes in connection with the virtual area based on the current model of the virtual area. In these examples, the virtual area specification 90 also typically specifies one or more follow-on rules for acting on area entry messages that grant one or more respective capabilities permitting one or more actions, behaviors, or states in the virtual area. In this case, the area service 82 typically responds to the area entry message by granting the one or more respective capabilities to the particular network node according to the one or more follow-on rules specified in the virtual area specification 90 for acting on the area entry messages.

In some examples, the virtual area specification 90: defines switching rules each of which includes a respective instruction for connecting sources of a respective data stream type with sinks of the respective data stream type in terms of associations of the sources and sinks with respective ones of the one or more zones of the virtual area; specifies a subscription message handling protocol for subscription messages of respective subscription types; specifies validation rules for validating subscription messages in connection with respective ones of the one or more zones and specifies follow-on rules for acting on subscription messages.

For a subscription message of a particular subscription type from a particular one of the network nodes in connection with a particular one of the one or more zones, the area service 82 handles the subscription message according to the subscription message handling protocol specified in the virtual area specification. In this process, the area service 90 identifies any validation rules specified in the virtual area specification 90 for validating subscription messages of the particular subscription type in connection with the particular zone, and validates the subscription message against each identified validation rule. In some of these examples, the process of validating the subscription message includes at least one of verifying that the particular subscription type previously was published to the particular node, and verifying that the particular network node has a capability permitting subscription to the particular subscription type in the particular zone. Based on validation of the subscription message against all the identified validation rules, the area service 82 identifies any follow-on rules specified in the virtual area specification for acting on subscription messages of the particular subscription type, and determines from the identified follow-on rules information enabling delivery of data streams associated with the particular subscription type to the particular network node according to the switching rules. The area service 82 then sends the determined information to one or more of the network nodes. In some of these examples, the particular subscription type is state data, in which case the subscription information includes state information describing state attributes of respective ones of the network nodes in the respective sessions associated with the virtual area. In some of these examples, the particular data stream type corresponds to media content, in which case the subscription information includes instructions for other network nodes to publish media content data streams associated with the particular subscription type in each of the one or more zones to which a respective presence attribute of the particular network node is linked.

In some examples, the virtual area specification 90: specifies a state message handling protocol for state messages; specifies validation rules for validating state messages in connection with respective ones of the one or more zones; and specifies follow-on rules for acting on state messages. For a state message comprising a change in an attribute of a particular one of the network nodes in connection with particular ones of the one or more zones, the area service 82 determines the state message handling protocol specified in the virtual area specification, and handles the state message according to the determined state message handling protocol. In this process, the area service 82 identifies any validation rules specified in the virtual area specification for validating state messages in connection with the particular ones of the one or more zone, and validates the subscription message against each identified validation rule. Based on validation of the state message against all the identified validation rules, the area service 82 identifies any follow-on rules specified in the virtual area specification for acting on the state message, and ascertains from the identified follow-on rules one or more changes to the model of the virtual area that reflect the change in the attribute of the particular network node. The area service 82 modifies the model of the virtual area based on the one or more ascertained changes to produce a current model of the virtual area, which is used to manage communications of respective ones of the network nodes in connection with the virtual area. In some examples, the area service 82 sends to the particular network node a notification that the attribute change was made.

In some examples, the area service 82 determines that additional modification of one or more of the attributes of the particular network node is required by respective rules specified in the virtual area specification as a result of the attribute change, and changes state information in the model of the virtual area to reflect the determined additional modification of the one or more attributes of the particular network node. The area service then sends to the particular network node a notification that the attribute change and the determined additional modification of the one or more attributes of the particular network node were made.

In some examples, based on failure to validate the state message against all the identified validation rules, the area service determines a current state of the particular node that reflects a revocation of the attribute change in the state message, and sends the determined current state to the particular network node.

In some examples, based on validation of the state message against all the identified validation rules, the area service 82 determines from the identified follow-on rules information enabling delivery of data streams between sources and sinks associated with the particular ones of the one or more zones according to the switching rules defined in the virtual area specification, and also determines subscription information for one or more data stream types that enable the particular network node to establish connections according to the switching rules. The area service 82 then sends the determined information to one or more of the network nodes associated with the particular ones of the one or more zones.

In some of these examples, the virtual area specification 90 specifies one or more attribute consistency rules that impose respective conditions on changes to attributes of network nodes in respective sessions associated with the virtual area, and the state message includes a change of a media control attribute of the particular network node. In these examples, the area service verifies that allowance of the media control attribute change would result in connections between media sources and media sinks of network nodes in respective sessions associated with the virtual area that are consistent with the one or more attribute consistency rules specified in the virtual area specification. The area service 82 also may verify that that allowance of the media attribute change would result in the particular network node having a respective presence attribute linked to each zone in which the particular network node is sourcing or sinking a respective realtime media data stream.

In some examples, the state change message includes a change of an application sharing attribute of the particular network node. In some of these examples, the area service 82 performance at least one of a verification that allowance of the application sharing attribute change would result in the particular network node having a presence attribute linked to a respective one of the zones from which application sharing data is being sourced and a verification that after the requested application sharing attribute change there would be only a single network node hosting a particular application sharing data stream sourced from a respective one of the zones.

In some examples, the area service 82 verifies that allowance of the attribute change would result in consistency of the attribute states of all the network nodes in respective sessions associated with the virtual area.

In some examples, the attribute change corresponds to linking a presence attribute of the particular node to a particular one of the one or more zones. In these examples, the area service 82 verifies that the particular network node has a capability that permits linking of the presence attribute of the particular node to the particular zone.

In some examples, the virtual area specification specifies one or more visibility rules controlling access to respective state information in respective ones of the one or more zones. In these examples, the area service propagates the ascertained changes to the model of the virtual area to each of the network nodes that are in respective sessions associated with the virtual area and are permitted to receive the ascertained changes according to the one or more visibility rules.

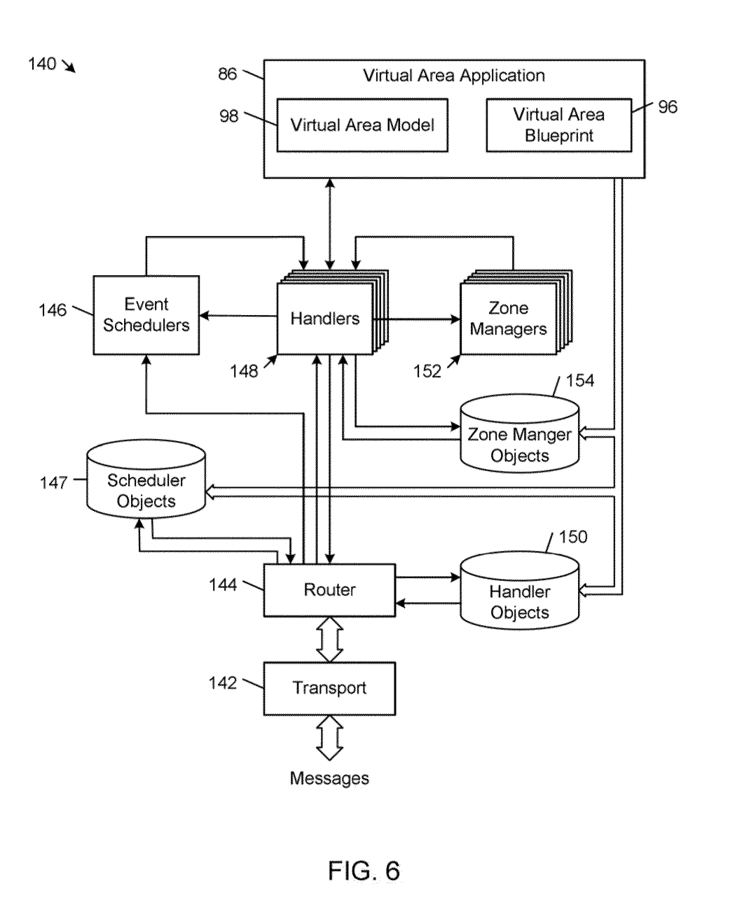

FIG. 6 shows an example 140 of a virtual area platform service architecture 140 that includes a transport service 142, a message routing service 144, event schedulers 146 that are instantiated from event scheduler objects 147, handlers 148 that are instantiated from handler objects 150, and zone managers 152 that are instantiated from zone manager objects 154.

In some examples, the message handling service architecture 140 executes virtual area applications that include the following definitions:

TABLE 1
AREA DEFINITION TYPES

| DEFINITION | |
|---|---|
| TYPE | DEFINITION SUBJECT MATTER |
| Rendering | Information needed by the client to draw the map and |
| and spatial | interact with objects in the spatial metaphor |
| information | |
| Channel | The list of channels published to the clients using this |
| definitions | application, their content and characteristics and the |
| | prerequisites to publication and the zone manager that |
| | provides rules based on subscribing and unsubscribing to |
| | the channel. |
| Zone | The list of zones defined by this application, including |
| definitions | rendering information and the governance rules that are |
| | triggered by entering, exiting or presence within the |
| | zone. |
| Zone Managers | Defines the zone managers used by this application and |
| | the zones and channels they govern. |
| Users | Defines different types of users of the application, |
| | including capabilities and attributes. |
| Audio | Defines a list of alternate audio configurations. These are |
| Configuration | used by the Audio zone manager to configure audio |
| | based on the characteristics and state of client and the |
| | characteristics of the zones the client is present in. |
| Messages | Defines the messages (e.g., SODA messages) that are |
| | handled by the application and their binary layout for |
| | marshalling and unmarshalling. |
| Message | Defines which Message Handlers process which SODA |
| Routing | messages for the application. Message Handlers can be |
| | platform supplied or developer supplied |
| Events | Defines an event to be scheduled upon receipt of a |
| | message or when a specific platform event occurs. If both |
| | events and message handlers are defined, events are |
| | scheduled after the final message handler has been run. |
| | Event handlers can be platform supplied or developer |
| | supplied |
| Props | Defines objects within a space that users can interact with |
| | in the client. |

The transport service 142 manages sessions between the server network node and other network nodes. In this process, the transport service 142 typically provides a local API that exports channels and sessions to the virtual area platform services in the application layer and a remote API for communicating in server sessions with communications services operating on the client network nodes. A network node (which may or may not be associated with a communicant) is associated with server node by a session. The session includes all the information about the state of the network node and the channels (e.g., chat channels and P2P audio channels) that are available to the network node. For example, a session may store a set of state attributes of the network node, along with respective links to the zones to which those attributes apply. For example, a presence attribute is a list of zones in which the communicant is present, and a microphone attribute is a list of zones in which the communicant's microphone is on. Each state data entry has a link to zero (e.g., microphone isn't on) or more zones. Given a channel, the area service can determine what session it belongs to. If a particular network node has multiple sessions, the zone managers other than the session zone manager would not be aware of it; the other zone managers work entirely on the session.

The transport service 142 also manages queues of incoming messages from the network transport layer of the server network node for delivery to the message routing service 144 and manages queues of outgoing messages generated by the virtual area platform service architecture 140 for delivery to the network transport layer of the server network node.

In the illustrated example, the event schedulers 146, handlers 148, and zone managers 152 are mapping tables for directory lookups that are defined in the virtual area application 86; these mapping tables instruct the platform which object to load for a particular operation.

The message routing service 144 receives incoming messages from the transport service 142. The message routing service 144 parses an incoming message to determine the node that transmitted the message, the particular virtual area application that is associated with the message, and the message type of the message. The message routing service 144 routes the incoming messages that are received from the transport service 142 either to the handlers 148 or the event schedulers 146 depending on the message type and the rules defined in the virtual area application for the message type. In some examples, messages are defined by area.

The message routing service 144 routes a message to the handlers 148 for synchronous handling. In this process, the message routing service 144 calls one or more handler objects 150 that are designated for handling the message type in the virtual area application 86 or in platform rules, and routes the message through the one or more instantiated handlers 148 according to rules defined in the virtual area application 86 or default platform rules.

In response to an event, the message routing service 14 calls one or more event scheduler objects 147 that are designated (e.g., in the virtual area application 86 or in the platform rules) for handling the event and passes the event to the one or more instantiated event schedulers 148. An event is defined (e.g., in the virtual area application 86 or in platform rules) as a trigger for scheduling an event (e.g., a state change or transmission of an outbound message). Examples of events include internally generated events (e.g., handler messages reporting platform events, such as application startup, application exit, client connect, and client disconnect) and externally generated events.

The handlers 148 are configured to process messages of respective message types. Handlers 148 may be platform supplied services or provided by the application designer or a third-party developer. Messages are processed one at a time, either in the order received or in packet number order, depending on message type. The handlers 148 may act on a message in a variety of different ways, including deriving information from a message, triggering an event (e.g., an event that triggers the transmission of an outbound message or state change), and calling another handler, a zone manager, or other service.

The event scheduler 146 schedules events (e.g., state changes or transmission of outbound messages) as a result of specific triggers. An event is scheduled on an event queue that typically is associated with a platform object such as a channel, session, client, application, or the platform itself. Events can be synchronous or asynchronous, delayed or immediate. Synchronous events are synchronized within, but not across, event queues. Examples of event types include: asynchronous events that are scheduled on a new thread independently of any other events as soon as the delay has expired; synchronous events that are first-only-scheduled to run only if an event of the same type is not currently scheduled to run sooner on the same queue; synchronous-last events that are only scheduled to run only if an event of the same type is not currently scheduled to run later on the same queue, and earlier events of the same type are cancelled if they have not yet run; synchronous events in which all scheduled events on the queue will be run in order, and earlier events must complete before new events are run; interval-first events, where only one event of this type will be allowed to run during the specified interval, newly scheduled events will be discarded if an event is already scheduled, or delayed if necessary if a prior event ran within the interval, and events are run asynchronously; interval-last events, where only one event of this type will be allowed to run during the specified interval, newly scheduled events will replace existing events that have not yet run, and events are run asynchronously; and custom events, which are developer-provided event types that allow customized scheduling rules.

The zone managers 152 enforce and apply rules for validating messages of respective message types in connection with respective ones of the one or more zones. The zone managers 152 may be platform supplied services or provided by the application designer or a third-party developer. The validation rules may be defined in, for example, any of a virtual area application 86, a platform specification, or a service specification. Each message that requires validation typically includes a set of sub-states for each governance zone that exists in the virtual area application 86, and the zone managers ensure that these sub-states are internally consistent by applying the rules defined for their respective zones of responsibility. The validation rules typically are driven by actions that are defined in the messages received from network nodes. Examples of the types of actions that typically are validated by zone managers include entering or exiting a virtual area application, subscribing to a data stream, and changing the state of a node or the virtual area.

The virtual area platform service architecture 140 is based on an indirect processing model in which a particular message is not tied to a particular action in area service code but rather is imposed by the definitions in the virtual area specification. The network communication environment created by a virtual area application may change in a variety of different ways. For example, if permitted by the virtual area application, communicants may manipulate the network communications environment directly (e.g., associate a particular viewscreen prop with a particular URL, as described in U.S. Provisional Patent Application No. 61/444,989, filed Feb. 21, 2011). Alternatively, the virtual area platform may change the network communications environment automatically in response to state changes. In some examples, state changes are described in idempotent state messages (also referred to as RdsState messages) each of which describes the complete state of an object (e.g., an avatar). For example, in the case of a communicant, an RdsState message may describe the communicant's zones of presence, the states of the communicant's microphone and headset, and whether or not the communicant is sharing or viewing a viewscreen prop. In some examples, an RdsState message for a communicant includes a set of payload packets each of which describes a respective state attribute. Each RdsState message represents a proposal from the transmitting network node that is validated by each of the zone managers whose scope encompasses the zones identified in the state message. RdsState messages are distinguished from RdsActivity messages. For example, RdsState messages are used for state changes, whereas RdsActivity messages carry transient activity reporting information (e.g., whether a communicant is typing a chat message, or talking into a microphone) that do not affect state.

After a state message has been validated by all of the applicable zone managers, the same zone managers act on the state message. In this process, the zone managers may make the requested state change or trigger other actions. In making the requested state change, one or more of the zone managers typically sends the requesting network node a return message that indicates whether or not the proposed state change was approved. In some examples, the return message may be an exact copy of the request message, which indicates to the requesting network node that the request was approved; alternatively, the return message may include the requested state change along with an additional state modification required by one or more governance rules that are enforced by the zone managers (e.g., the proposed microphone state change is approved, along with an automatic change in the state of the communicant's headset from the “off” state to the “on” state); or the return message may include an indication that the proposed state change was rejected, which may be carried out, for example, by sending the network node a state message corresponding to the state of the network node just before the proposed state change.

A state change may be a trigger for a variety of actions. For example, if a first communicant turns on his microphone in the virtual office of a second communicant, the communications application running on the client network node being operated by the first communicant will send a state message that includes the microphone state change. One or more zone managers that are associated with the virtual office will validate the proposed microphone state change. If the proposed state change is validated, one or more of the zone managers will trigger audio routes to be created from the first communicant to each of the other communicants in the virtual office whose headset is turned on. If the second communicant turns on his microphone, the same process is repeated and, if the proposed state change is validated, one or more of the zone managers will trigger an audio route to be created from the second communicant to each of the other communicants in the virtual office whose headset is turned on. Note that the action trigger is not an explicit request from a network node. Instead, the action trigger is a proposed state change (e.g., a communicant turns on a microphone while present in a virtual room), and the zone managers apply the rules of the virtual area to carry out the effect of the proposed state change in the context of the virtual area according to the designer's specification (e.g., if a communicant turns on his microphone, an audio stream should be created from the communicant's network node to the network nodes of each of the other communicants in the zone whose network nodes can sink the audio stream). In other words, the actions that are triggered as a result of a proposed state change are not actions that are explicitly requested by the network node.

Some governance rules are designed to ensure that the set of states related to a zone are consistent with a desired policy or objective. For example, a global governance rule may be defined to ensure that a communicant who is outside a particular zone cannot receive audio streams that are transmitted between communicants who are in that zone. In some examples, the enforcement of such governance rules by zone managers prevents third-party developers from developing client communications applications that attempt impermissible state changes (e.g., turn on a headset in a zone without being present in the zone).

Based on the virtual area application 86, the virtual area platform service architecture 140 to dynamically assemble the handlers 148 and the zone managers 152 into different service configurations to act on different types of messages that are received from network nodes.

In some examples, the server node 80 manages network node communications by executing the virtual area platform service architecture 140. In accordance with this method, the server node 80 creates the virtual area model 98 based on a virtual area specification 90 that defines one or more zones of the virtual area, designates handlers for handling messages of respective message types, and designates zone managers for processing messages of respective message types in relation to respective ones of the zones according to respective rules. The server node 80 acts on each of multiple messages of respective ones of the message types received from respective network nodes in connection with respective ones of the one or more zones. In this process, the server node 80 ascertains one or more of the handlers 148 designated in the virtual area specification 90 for handling messages of the respective message type. With the one or more ascertained handlers 148, the server node 80 identifies one or more of the zone managers 152 designated in the virtual area specification 90 for processing messages of the respective message type in relation to the respective zone. With each of the identified zone managers 152, the server node 80 validates the message according to one or more of the respective rules. Based on a validation of the message by all the identified zone managers 152, one or more of the identified zone managers 152 determines one or more changes to the virtual area model 98. The server node 80 modifies the virtual area model 98 based on the one or more determined changes to produce a current model of the virtual area. The server node 80 manages communications of respective ones of the network nodes in connection with the virtual area based on the current model of the virtual area.

The one or more ascertained handlers typically call the one or more identified zone managers to process the message. In some examples, with one or more of the identified zone managers the server node 80 modifies the virtual area model 98 and triggers an event for propagating changes to the model of the virtual area to respective ones of the network nodes linked to the virtual area.

In some examples, the virtual area application 86 defines an area entry message handling protocol for handling area entry messages. In these examples, the virtual area specification 90 designates at least one handler for handling area entry messages, and designates at least one of the zone managers for processing area entry messages in relation to one or more respective ones of the zones according to respective rules. The server node 80 acts on an area entry message transmitted by a particular one of the network nodes requesting entry into the virtual area. In this process, at least one of the handlers designated in the virtual area specification for handling the area entry message determines the at least one zone manager designated for processing the area entry message, and one or more of the at least one determined zone manager determines one or more changes to state information in the model of the virtual area to reflect entry of the particular network node into the virtual area. In some of these examples, one or more of the at least one determined zone manager determines one or more changes to a state attribute of the particular network node to reflect entry of the particular network node into the virtual area, and makes the one or more determined changes to the state attribute of the particular network node in the virtual area model 98. In some of these examples, one or more of the at least one determined zone manager grants to the particular network node one or more capabilities permitting one or more actions, behaviors, or states of the particular network node in the virtual area.

In some examples, the virtual area application 86 defines a subscription message handling protocol for handling subscription messages of respective subscription types. In these examples, the virtual area specification designates at least one of the zone managers for processing subscription messages in relation to respective ones of the zones according to the respective rules. The server node acts on a subscription message from a particular one of the network nodes and requesting subscription to a particular data stream type in a particular one of the zones. In this process, with at least one of the handlers designated in the virtual area specification for handling the subscription message, the server node 80 determines the at least one zone manager designated for processing the subscription message; with each of the at least one determined zone manager, the server node 80 validates the subscription message according to one or more of the respective rules; based on validation of the subscription message, one or more of the at least one determined zone manager determines subscription information for the particular data stream type according to the switching rules; and the server node 80 sends the subscription information to the particular network node.

In the process of validating the subscription message, the server node 80 may verify that the particular data stream type was published to the particular node with one or more of the at least one determined zone manager and/or verify that the particular network node has a capability permitting subscription to the particular data stream type in the particular zone.

In some examples, the particular data stream type is state data, and the subscription information includes state information for the network nodes associated with the virtual area. In other examples, the particular data stream type corresponds to one or more media data stream types, and the subscription information comprises information for receiving media data streams of the one or more media data stream types that are sunk by all of the zones to which a presence attribute of the particular network node is linked.

In some examples, the virtual area application 86 specifies a state message handling protocol for handling state messages. In these examples, the virtual area specification designates at least one of the zone managers for processing state messages in relation to respective ones of the one or more zones according to the respective rules. The server node 80 acts on a state message that includes a change in an attribute of a particular one of the network nodes. In this process, with at least one of the handlers designated in the virtual area specification for handling the state message, the server node 80 determines the at least one zone manager designated for processing the state message. With each of the at least one determined zone manager, the server node 80 validates the state message according to one or more of the respective rules. Based on validation of the state message, with one or more of the at least one determined zone manager, the server node 80 determines one or more changes to state information in the model of the virtual area that reflect the change in the state attribute of the particular network node.

In some examples, based on a validation of the state message by all the identified zone managers, the server node 80 sends to the network node that sent the state message a notification that the attribute change was made.

In some examples, based on a validation of the state message by all the identified zone managers, one or more of the at least one determined zone manager determines that additional modification of the attributes of the particular network node is required by the respective rules as a result of the attribute change, changes state information in the model of the virtual area to reflect the attribute change and the additional modification of the attributes of the particular network node, and triggers an event or sending to the network node that sent the state message a notification that the attribute change and the additional modification of the attributes of the particular network node were made.

In some examples, based on a failure to validate the state message by all the identified zone managers, one or more of the at least one determined zone manager triggers an event for sending to the network node a definition of the current state of the network node.

In some examples, based on validation of the state message, one or more of the at least one determined zone manager determines subscription information for one or more data stream types that the particular network node can establish connections for according to the switching rules, and triggers an event for sending the subscription information to the particular network node. In some of these examples, the state message includes at least one of a change of a media attribute of the particular network node, and the process of validating the state message involves with one or more of the at least one determined zone manager verifying that allowance of the media attribute change would result in connections between media sources and media sinks of network nodes in the virtual area that are consistent with the respective rules. In some examples, the verification process involves verifying that that allowance of the media attribute change would result in the particular network node having a respective presence attribute linked to each zone in which the particular network node is sourcing or sinking a respective realtime media data stream. In some examples, the state change message includes a change of an application sharing attribute of the particular network node, and the verification process involves verifying that allowance of the application sharing attribute change would result in the particular network node having a presence attribute in a respective one of the zones from which application sharing data is being sourced. In some examples, the verification process involves verifying that after the requested application sharing attribute change there would be only a single network node hosting a particular application sharing data stream sourced from a respective one of the zones. In some examples, the verification process involves verifying that allowance of the attribute change would result in consistency of the attribute states of all the network nodes in the virtual area. In some examples, the attribute change corresponds to a change in a presence attribute of the particular node to be linked to a particular one of the zones, and the verification process involves verifying that the particular network node is permitted to be present in the particular zone.

In some examples, one or more of the at least one determined zone manager triggers an event for broadcasting the one or more changes to the state information to network nodes that have a presence attribute linked to one or more zones of the virtual area and are permitted to receive the state information.

In some examples, the server node 80 acts on a state message that includes a change of a presence attribute of a respective one of the network nodes into a particular one of the zones. In this process, based on a validation of the state message by all the identified zone managers, with one of more of the identified zone managers the server node 80 determines sink subscription information indicating the one or more specified data stream types that are sinkable into the particular zone, and triggers an event for sending the sink subscription information to the respective network node. In some of these examples, based on a validation of the state message by all the identified zone managers, with one of more of the identified zone managers the server node 80 determines source subscription information indicating the one or more specified data stream types that are sourceable from the location zone, and triggers an event for sending the source subscription information to the respective network node.

A zone definition typically includes definitions that specify which area zone managers provide governance and control channels that are used by the zone managers in each zone. A non-rendered governance zone typically encompasses a collection of one or more rendered location zones. One or more control channels are defined within a governance zone. A governance zone functions as a “sink” for data sent on the associated control channel, whereas a location zone that specifies the same control channel functions as the “source” of the control channel data. A user who is present in any one of the location zones within a governance zone is also present within the governance zone.

A control channel is a collection of channels that share a common definition that is managed by exactly one area zone manager. A control channel is published by its corresponding zone manager when a communicant enters a zone that the zone manager has responsibility for. For example, a chat control channel describes the chat channels that exist (i.e., the channels that contain the chat data). When a communicant enters a room, the chat control channel publishes the chat channels that are available for the room, the communicant's client communicants application subscribed to a particular chat channel and the chat history was sent down to the client communications application on that channel. A single area zone manager can manage multiple control channels. When a message is passed from a message handler to a zone manager, the message handler sends the zone manager the ID of the control channel on which the message came on so that the zone manager operate in the correct context defined by the control channel ID.

In one example, a virtual area specification defines a virtual area that includes a main conference room with a private alcove off the main conference room, one or more governance rules that prescribe that, when in the alcove, a communicant receives audio from the main conference room at a 50% reduced volume and receives the audio in the alcove at full volume, a first control channel that encompasses the main conference room and the alcove, and a second control channel encompasses only the alcove. The first control channel instructs client and proxy nodes in the main conference room to configure audio channels with one another and the second control channel instructs client and proxy nodes in the alcove to configure audio channels with one another. The virtual area specification may define a single zone manager to manage both control channels. In managing the first control channel, the zone manager would deliver the audio in the main conference room at full volume to communicants who are in the main conference room and deliver the audio in the main conference room at 50% reduced volume to communicants who are in the alcove. In managing the second control channel, the zone manager would deliver the audio in the alcove (at full volume) only to the communicants in the alcove. Thus, when a network node transmits a state change message (e.g., an RdsState message) in connection with the virtual area, the zone manager may receive the RdsState message on one or both of the channels and its behavior will depend on which channel the message was received. In this way, the zone manager operates in the context defined by the data in the state change message.

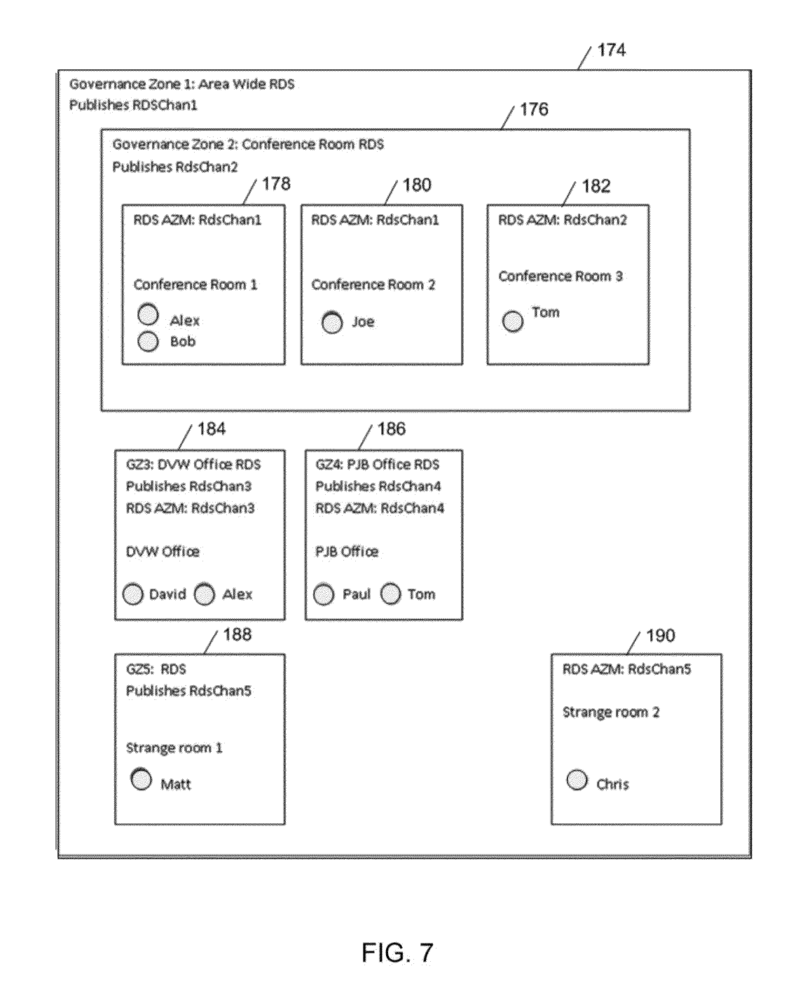

FIG. 7 shows an example of a realtime data stream (RDS) zone map that defines how RDS streams are sourced and sunk in a virtual area. The virtual area specification may include analogous zone maps for other channels that are defined for the virtual area. Some control channels, such as the session control channel and the area definition channel, only have a single instance. In the example shown in FIG. 7, the virtual area includes seven locations: Conference Room 1, Conference Room 2, Conference Room 3, DVW Office, PJB Office, Strange Room 1, and Strange Room 2. The virtual area also includes five governance zones: a global area wide zone 174, a zone 176 containing all three conference rooms, zones 178, 180, 182, 184, 186 for each office (which coincide with the location zones), and zones 188, 190 for Strange Room 1 and Strange Room 2.

Alex is present in Conference Room 1, GZ1, GZ2 and DVW Office (GZ3), Bob is present in Conference Room 1, GZ1 and GZ2, Joe is present in Conference Room 2, GZ1 and GZ2, Tom is present in Conference Room 2, GZ1, GZ2 and PJB Office/GZ4, David is present in DVW Office/GZ3 and GZ1, Paul is present in PJB Office/GZ4 and GZ1, Matt is present in Strange Room 1/GZ5 and GZ1, and Chris is present in Strange Room 2 and GZ1.

There are five control channels for RDS, one published by each zone except zone 190, which does not publish any RDS data: RDSChan1 is published by zone 174; RdsChan2 is published by zone 176; RdsChan3 is published by zone 184; RdsChan4 is published by zone 186; and RdsChan5 is published by zone 188. RDS activity in a zone is sent out on all RDS zone manager control channels for that zone and delivered to all users present in the governance zones that publish those control channels.

In the example shown in FIG. 7, activity in any of conference room 1 or conference room 2 is published on RdsChan1, which is published by an area zone manager for governance zone 174. Since every user in the area is in governance zone 174, all users in the area are subscribed to RdsChan1 and see the RDS activity in Conference Rooms 1 and 2 (governance zones 178, 180). An area zone manager for governance zone 182 publishes activity in Conference Room 3 (governance zone 182) on RdsChan2. In this case, only Alex, Bob, Joe and Tom are in governance zone 176, so only they are subscribed to the channel and see Tom's Activity in Conference Room 3. Since RdsChan1 is not a control channel for Conference Room 3, activity in Conference Room 3 is not broadcasted on that channel. Activity in the DVW Office is sent out on RdsChan3, which is published by governance zone 184 and therefore is only visible to David and Alex since they are the only ones present in that zone. Likewise, activity in the PJB Office is sent out on RdsChan4, which is published by governance zone 186 and therefore is only visible to Paul and Tom since they are the only ones present in that zone. Activity in Strange Room 1 is not visible anywhere, not even in Strange Room 1 since it doesn't specify an RDS Control Channel. Activity in Strange Room 2 is sent out on RdsChan5, which is published by governance zone 188 and therefore is broadcast to Matt in Strange Room 1. Thus, no one can see Matt's activity in Strange Room 1 (not even Matt) and only Matt can see Chris's activity in Strange Zone 2.

In some examples, the server node 80 communicates with the client nodes 12, 14 and the proxy node 19 in accordance with the stream transport protocol described in U.S. patent application Ser. No. 12/825,512, filed Jun. 29, 2010, and U.S. patent application Ser. No. 12/630,973, filed Dec. 4, 2009. The stream transport protocol supports remote management of client communication sessions and remote configuration and execution of audio and graphic rendering engines, as well as switching of data streams in response to instructions (also referred to as definitions) that are received from a remotely hosted virtual area application. The stream transport protocol is efficient in connection and disconnection, as well as in transport. In some examples, the stream transport protocol provides a connection-oriented, encrypted connection over a transport protocol (e.g., UDP, TCP, HTTP, and PPP). The stream transport protocol additionally provides between a client application and the transport layer a reconnection mechanism that automatically attempts to reestablish failed connections without intervention by the client application, thereby adding reliability on top of an inherently unreliable communication protocol.

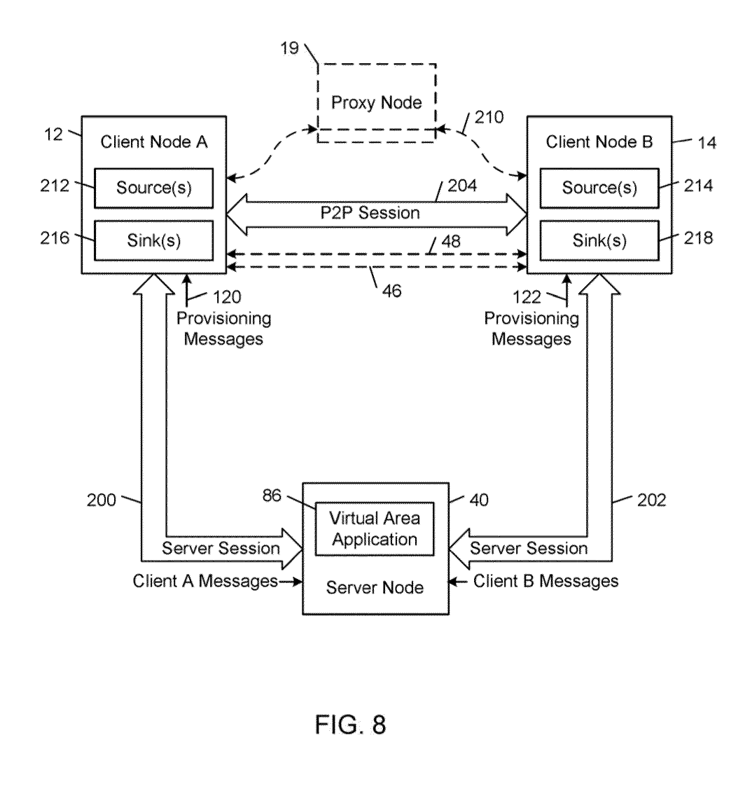

FIG. 8 shows an exemplary set of sessions that may be established between the client nodes 12, 14 and the server node 40. In this example, the client nodes 12, 14 establish respective server sessions 200, 202 with the server node 40. Each of the server sessions 200, 202 is established over a respective network connection between a respective one of the client nodes 12, 14 and the server node 40. In addition, each of the client nodes 12, 14 also establishes a peer-to-peer (P2P) session 204 over a network connection between the client nodes 12, 14. The client nodes 12, 14 also may establish and keep alive one or more alternate (or backup) connections 206, 208, 210 that may be used as failover connections for reestablishing a P2P session between the client nodes 12, 14 in the event that the original P2P session fails. In the illustrated example, the alternate network connection 210 is established through the proxy node 19, which simply relays messages (including session negotiation messages) between the client nodes 12, 14.

In the server sessions 200, 202, the server node 40 sends to each of the client nodes 12, 14 provisioning messages 120, 122 that configure the client nodes 12, 14 to interconnect respective data streams between active ones of their complementary sources and sinks in accordance with switching rules specified in the virtual area application 86.

Sessions between the network nodes can be established over any type of serial communications protocol stream (e.g., UDP, TCP, HTTP, and PPP). In some examples, a stream is a bi-directional UDP socket between two network nodes defined by two IP address/port pairs, and a transport GUID. A stream supports sessions of channels. A session is a logical node-to-node connection. Sessions transport channels for the two nodes. Sessions may pass through one or more proxy nodes and are transported over streams that may contain multiple sessions.

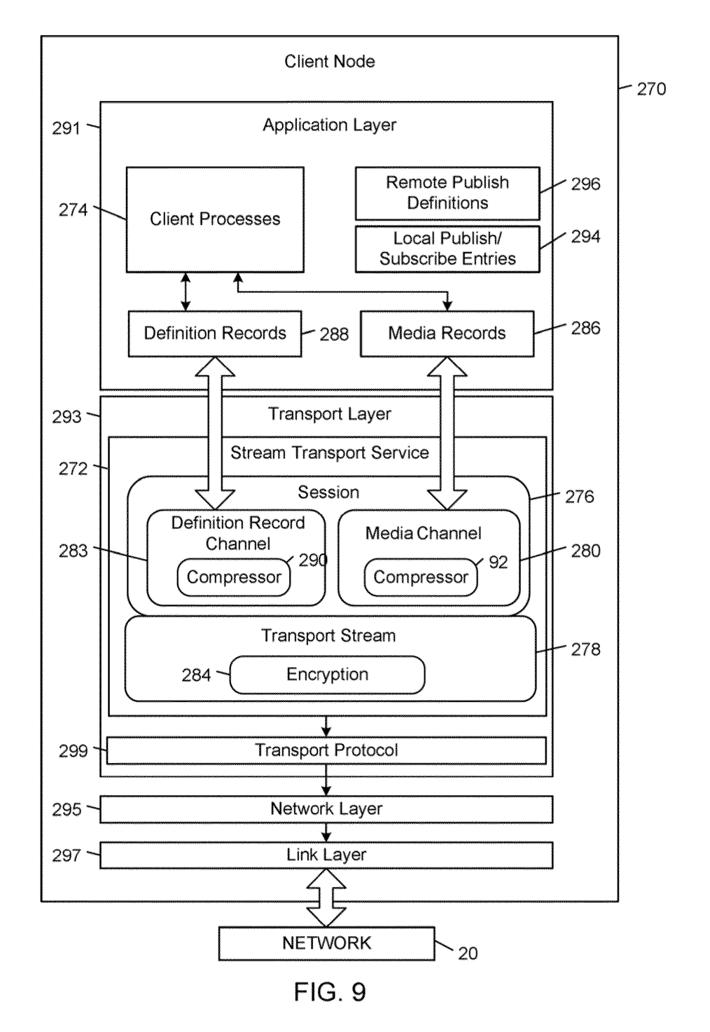

FIG. 9 shows an example of a client network node 270 that includes a stream transport service 272 and other client processes 274 that, together, constitute a thin client communications application for rendering a communication environment in accordance with instructions that are received from the server node 40. The stream transport service 272 and the other client processes 274 operate at different levels—from network features through audio and graphics rendering configuration. The stream transport service 272 manages sessions between the client network node 270 and other network nodes. In this process, the stream transport service 272 typically provides a local API that exports channels and sessions to the client processes 274 in the application layer and a remote API for communicating in a server session with communications services operating on the server network node 40.

In some examples, the communications applications 26, 32 on the client nodes 12, 14 typically include respective graphical user interface (GUI) applications that provide a visual interface for visualizing and controlling communicant interactions. These GUI applications are configured to communicate with the virtual area application 86 through the local stream transport service API. In some examples, the GUI application is a remote-controlled terminal application that is configured to pass user proposals (e.g., user proposed state changes) to the respective ones of client processes 274 implementing the local API and to render graphical data (e.g., chat data and graphical content, such as screen share data) received from these client processes 274. These client processes 274 implementing the local API communicate with the stream transport service 272 in order to publish messages containing definitions of user inputs on the appropriate sessions and channels and to subscribe to data received from remote network nodes on the appropriate sessions and channels. In addition, one or more of the client processes 274 are remotely configured by instructions received from the communications services on the server network node 40 to create (and tear down) data processing component graphs for processing inbound data received from other client network nodes. For example, some examples include a remotely configurable audio processing service of a realtime kernel that creates and tears down graphs of audio processing components in response to definitions received from the communications services on the server network node 40. Additional details regarding an exemplary realtime kernel that includes remotely configurable processing components are provided in U.S. application Ser. No. 12/630,973, filed Dec. 4, 2009.

During a session, data is shared between the client network node 270 and other network nodes as definition records over transport protocol sockets. The thin client architecture receives configuration instructions from the server node 40 through definition records that are received over the server session. The thin client architecture also receives content from other client network nodes through definition records that are received on content-specific channels on respective sessions with the other client network nodes. Data is shared in accordance with a publish/subscribe model. The stream transport service 272 subscribes only to the data that are needed by the client network node 270. To subscribe, the stream transport service 272 negotiates a channel on a session that is established with another network node. The channel is negotiated by well-known GUID for the particular virtual area application 86. Definition records are transmitted only when a subscriber exists on the other end of a transport protocol socket. Definition records that are received by the stream transport service 272 are delivered to the subscribing ones of the client processes 274 on arrival.

As shown in FIG. 9, the stream transport service 272 manages a session 276 on a transport stream 278. In some examples, a transport stream in the context of a stream transport protocol session is defined by a pair of {IP, port} addresses and a transport GUID, which identifies a transport protocol (e.g., UDP) that is used to create the stream. A session 276 consists of zero or more logical channels, where a channel is a sequence of definition records that are appropriate for a particular client process 274 (e.g., a graphics engine, an audio manager, and a stream switching manager). Thus, the same transport stream 278 on a single socket can transport definition records on different channels, each of which can be subscribed to by zero, one, or multiple of the client processes 274. In the illustrated example, the stream transport service 272 manages two kinds of channels: media channels 280 that contain streaming media records 286 (e.g., audio packets); and definition record channels 282 that contain records of definitions 288. Examples of media records 286 include audio codec and text. Examples of definition records 88 include session maintenance definitions (e.g., keepalive/acknowledgement definition records), client provisioning definitions (e.g., definitions of processing graph elements, such as audio processing elements), definitions of 3D rendering assets (e.g., texture and mesh), and definitions of RDS.

The definition records 288 and the media records 286 are encapsulated in stream transport protocol records. The stream transport protocol records are encrypted by an encryption process 284, sequenced with packet numbers, and include a message integrity field. The sequencing of the stream transport protocol records is independent of the record source or purpose—it is a link-level feature used to detect out-of-order or missing records. The stream transport protocol records are identified by channel. GUIDs are used as channel identifiers. Definition records 288 and media records 286 may be compressed at the channel level using respective channel-specific compressors 290, 292, independently of the stream transport protocol record encapsulation. Each stream transport protocol record typically contains one or more definition records 288 or one media packet 296. The stream transport protocol records are delivered over the transport stream 278 as payloads of packets that are formatted in accordance with a transport protocol (e.g., UDP, TCP, HTTP, and PPP).

In some examples, the stream transport protocol records are STRAW (Sococo TRAnsport for WAN) packets, as described in and U.S. patent application Ser. No. 12/630,973, filed Dec. 4, 2009. A STRAW packet starts with a STRAW Record, which has a 128-bit Channel ID (which is a universally unique ID or “UUID”), a 16-bit Flag field, an 8-bit version field, an 8-bit key field, a 64-bit cookie field, a 32-bit MAC field, a 16-bit Packet Number, an 8-bit Extension Type field, an 8-bit Extension Length field, and an optional Extension Protocol field. The KEY field identifies the cipher used to encrypt the message (0 means not encrypted). The Packet Number starts at zero and increments with each packet in the stream. When the Packet Number reaches 65535, it returns to zero and keeps counting. The packet number and Flags are in “Big-Endian” order. Following the STRAW Record is the data packet that contains SODA (Sococo Definition Architecture) records. A SODA record contains one or more SODA definitions. Examples of SODA definitions session maintenance definitions (e.g., keepalive/acknowledgement definition records), client provisioning definitions (e.g., definitions of processing graph elements, such as audio processing elements), definitions of 3D rendering assets (e.g., texture and mesh), and definitions of RDS (e.g., avatar motion checkpoints).

In these examples, sessions are divided logically into channels that are identified by the identifier contained in the first field (i.e., the Channel ID field) of a STRAW Record. Exemplary types of channels include session channels, station channels, and media channels (also referred to herein as “content” channels). Session channels are identified by the presence of a session identifier in the Channel ID field of STRAW Records and are designated for carrying data (e.g., StreamStats, Pings, and Keepalive messages) relating to session management tasks. Station channels are identified by the presence of a station identifier in the Channel ID field of the STRAW Record and are designated for carrying data relating to network address resolution tasks. Media channels are identified by the presence of a content identifier in the Channel ID field of the STRAW Record and are designated for carrying media data (e.g., audio data, video data, chat data, and screen share data).

In the example shown in FIG. 9, the stream transport service 272 is a component of a four-layer protocol suit that includes an application layer 291, a transport layer 293, a network layer 295, and a link layer 296. The application layer 291 contains user-level processes that interface the communicant to the network. The transport layer 291 includes the stream transport service 272 and a transport protocol 299 (e.g., User Datagram Protocol (UDP)), and interfaces the application layer 293 with the network layer 295. The network layer 295 manages movement of data through the network in accordance with one or more protocols (e.g., Internet Protocol (IP), Internet Control Message Protocol (ICMP), and Internet Group Management Protocol (IGMP)). The link layer 297 manages the details of physically interfacing with the network media (e.g., Ethernet cable, etc.) and typically includes a device driver component of the operating system and the physical network hardware components (e.g., Network Interface Card (NIC)) of the client node 270.

In some examples, the network nodes share data in accordance with a publish/subscribe model, which typically is connectionless. In these examples, the client nodes 12, 14 subscribe to only the data they need. The server node 16 determines what channels are needed by each of the client nodes 12, 14 based on the respective states (i.e., active or inactive) of their sources and sinks. The virtual area platform sends to each of the client nodes 12, 14 respective publish messages indicating what information streams are available for that client, tagging each stream with a GUID handle. Each of the client processes 274 operating on each client node may subscribe to zero or more of the channels. A client process 274 that subscribes to a channel registers with the local stream transport service 272 to receive notification of channel state changes and channel records as they arrive. Each of the client nodes then subscribes to the desired channels from the other client nodes using well-known channel GUIDs that are specified by the virtual area application 86. Any changes to server data for a particular channel will be sent as definition records to all the clients that have subscribed to that channel.

The client network nodes 12, 14 share data with each other in accordance with a publish-and-subscribe data sharing model. In this method, a local client network node receives from a server network node an identification of local publish channels that are publishable from the local client network node. These publish channels correspond to content that can be sourced from the local client network node. The local client network node stores a register identifying the local publish channels that are publishable from the local client network node and local subscribe channels associated with one or more local software entities on the local client network node. The local client network node establishes a peer-to-peer session with a remote client network node. The local client network node publishes the local publish channels and the local subscribe channels on the peer-to-peer session. In response to receipt of publication of one or more remote publish channels on the peer-to-peer session, the local client network node sends to the remote client network node a subscribe request for each of the local subscribe channels matching a respective one of the remote publish channels. In response to receipt of data on a peer-to-peer session in a content channel matching a respective one of the local subscribe channels, the local client network node passes the received data to each of the local software entities associated with the matching local subscribe channel. In response to receipt of a request to subscribe to a respective one of the local publish channels on the session, the local client network node sends to the remote client network node data associated with the respective local publish channel.

The stream transport service 272 maintains a register 294 (e.g., a table) of local publish and subscribe entries. Each entry in the list contains:
An identifier of the local client process 274 that created the entry
A server identifier
A channel identifier
An indication of whether the entry is a publish entry or a subscribe entry
(for Subscribe) One or more transport parameters
   The register 294 of local publish and subscribe entries is initialized with
{StreamTransportServiceID, GUID_NULL, SessionChannelID, Subscribe, Reliable, Uncompressed}
   In this way, the stream transport service 272 (which is identified by the StreamTransportServiceID) subscribes to all arriving definitions records 88 arriving on any session channel, including publish and subscribe definition records. The GUID_NULL channel is never published and every server assumes the GUID_NULL channel to be subscribed with a well-known channel ID on every transport stream.

The stream transport service 272 also maintains a register 296 of all arrived publish definitions, for use in case a late subscribe is registered in the local list.
{IDClient, IDServer, IDChannel}
   Where IDClient is a (possibly NULL) GUID of a particular client process 74 for which the channel is intended, IDServer is the remote source of channel records and IDChannel is a well-known GUID of a channel.

When the stream transport service 272 receives a session definition for a connection to another station, the stream transport service 272 establishes the stream, sends the session definition, and then sends all of the stored local publish entries in a definition record on the session channel. When a publish definition arrives at a stream transport service 272, the stream transport service 272 enters that definition into the publish definition table and then sends a subscribe definition on the session channel for each subscribe entry in the local list that had a matching Channel ID in the publish record. When a subscribe definition arrives, the stream transport service 272 begins sending definition updates (piped from the publishing virtual area application 40) on the given definition record channel containing the definition records for that definition. The definition records may be sent on more than one channel.

When a client process 274 desires to participate in a channel with a server, the client process 274 defines a subscribe request, whether or not any transport streams exist to any servers. If the virtual area platform publishes later (i.e., after stream is established) then the change in the local table triggers re-sending of the publish entries in the remote publish definition table 296, which automatically triggers any latent subscribe on the other end of the transport stream. If a client process 274 subscribes later and there is an entry in the publish table 296, then the stream transport service 272 sends the subscribe request automatically. This process ensures that channel data is sent over a transport stream only if it is desired by the receiver.

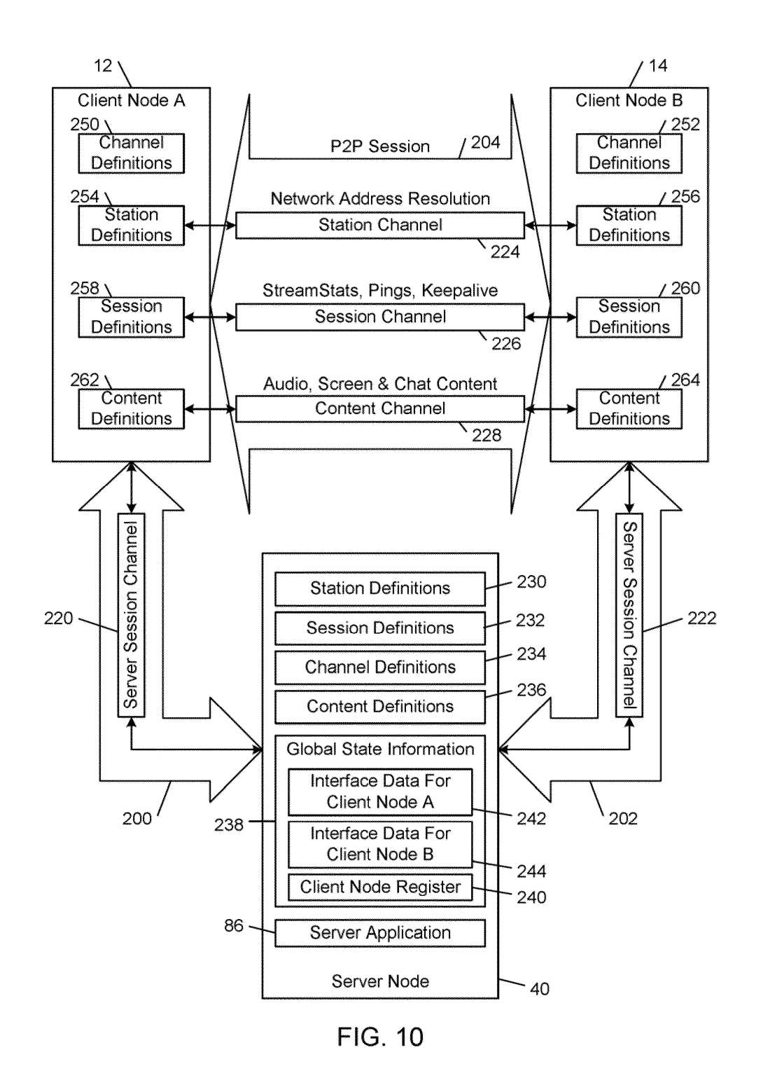

FIG. 10 shows an example of the network communications environment 10 in which the client and server network nodes 12-16 communicate on various channels in the respective sessions 200-204 that are established between the network nodes 12-16. In the illustrated example, the server node 40 communicates with each of the client nodes 12, 14 on a respective server session channel 220, 222 in the server sessions 200, 202, and the client nodes 12, 14 communicate with each other on a station channel 224, a session channel 226, and a content channel 228 in the peer-to-peer session 204. In some examples, data is shared between respective nodes in a session as definition records over STRAW sockets in accordance with a publish/subscribe model, as described in U.S. patent application Ser. No. 12/825,512, filed Jun. 29, 2010. The instances of the stream transport service operating on the client nodes 12, 14 subscribe only to the data that are needed by the client network nodes. To subscribe, a stream transport service instance creates a STRAW channel to a target network node by negotiating a particular Channel ID, which is a well-known UUID in the namespace defined for the virtual area application 86.

The server node 40 maintains data for provisioning the client nodes 12, 14 to communicate in accordance with the virtual area application 86. Among the types of data that the server node 40 maintains are station definitions 230, session definitions 232, channel definitions 234, and content definitions 236. The server node 40 also maintains global state information 238 that includes a current register 240 of the client nodes that are connected to the server application and interface data 242, 244 that identifies the data sources and sinks of the client nodes and the respective states of the sources and sinks (i.e., active or inactive).

The server network node creates a universally unique Channel ID per content type for each pair of currently active complementary sources and sinks between session partners (e.g., an audio channel from node 1 to node 2 and an audio channel from node 2 to node 1). Therefore, each of the currently available channels is identified by a respective Channel ID that is unique to the current conversation between the client network nodes and messages sent with that Channel ID can be trusted as being authentic and from the session partner. For example, in response to receipt of a message from the a first session partner to turn off its local microphone, the server node 40 instructs the second session partner to tear down its microphone audio channel processing graph, which removes the associated subscribe to the original audio channel; and in response to a message from the first session partner to turn back on the local microphone, the server node 40 creates a new audio channel with a new unique Channel ID and instructs the second session partner to subscribe to the new audio channel and to create a new microphone audio processing graph for processing the microphone data on the new audio channel. The second session partner will ignore any packets that are received on the original audio channel after receipt of the instruction to tear down the original microphone audio channel processing graph.

The server node 40 provisions each of the client nodes 12, 14 for communicating in accordance with the virtual area application 86 by sending definition records over the respective server session channel 220, 222. In this process, the server node 40 sends publish messages indicating the channels that are available to the client nodes 12, 14, tagging each with a GUID handle. The instances of the stream transport service operating on the client nodes 12, 14 send subscribe messages for the desired data streams to the server node 40. Any changes to the provisioning data for the subscribed channels are sent as definition records to all client network nodes that have subscribed to those channels.

Over each of the server sessions, the server network node transports control messages of different content types on different respective channels that logically divide the control messages by content type. Each of the control messages typically is sent with a unique server session identifier that is assigned to the server session. The content type of a control message is determined from the channel ID. In some examples, the server network node transmits to each of the client network nodes connected to the server application the respective unique station identifiers that are assigned to the other client network nodes. In some of these examples the server network node also transmits a station definition of a proxy server to each of the client network nodes connected to the server application. The station definition of the proxy server typically includes the respective station identifier assigned to the proxy server and one or more entries each of which includes a respective network address and a respective protocol port identifier for a protocol port on the proxy server.

In response to receipt of the definition records from the server node 40, the respective instances of the stream transport service operating on the client nodes 12, 14 update locally stored tables containing channel definitions 250, 252, station definitions 254, 256, session definitions 258, 260, and content definitions 262, 264. These definitions are used by the instances of the stream transport service to determine whether or not to process incoming data packets and to determine how the incoming packets should be demultiplexed for consumption by the stream transport service and the other client processes.

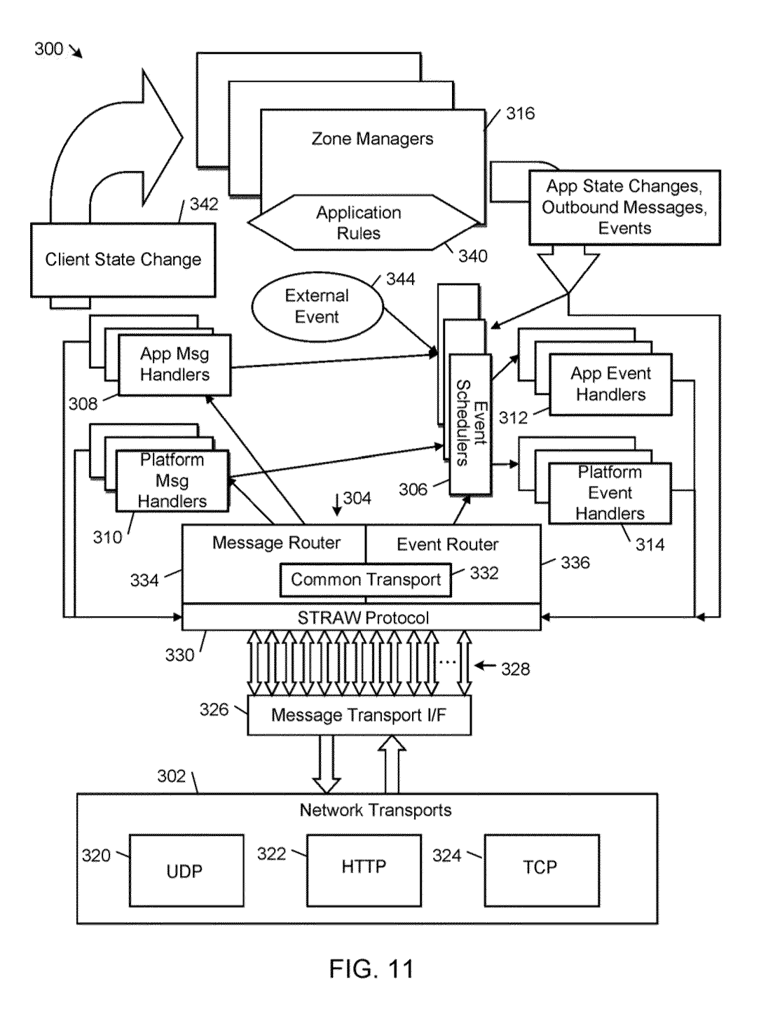

FIG. 11 shows of an example 300 of the message handling service architecture 140 (shown in FIG. 6) that includes network transports 302, a router 304, event schedulers 306, application message handlers 308, platform message handlers 310, application event handlers 312, platform event handlers 314, and zone managers 316. The message handling service architecture 300 is a message driven-rules engine and messaging system.

In the context of the message handling service architecture 300, messages are defined in the virtual area specification and include a well-known UUID, a length field and a well-defined or predictable layout. When a message is received from a network node, the message is processed by one or more message handlers designated in the virtual area specification for handling the message. Messages are processed synchronously on a single channel and asynchronously across channels (only one message at a time will be processed on a single channel, but multiple messages from a user can be simultaneously processed if they are on different channels)

Events are used to schedule a state change and/or outbound message as the result of some trigger. Triggers can be external changes (e.g., database triggers, or invoked by other servers) or configured in the virtual area specification to be triggered by messages or platform events (e.g., application startup, application exit, client connect, and client disconnect). An event is scheduled on an event queue, which is associated with a platform object (e.g., a channel, session, client, application, and the platform itself). Events can be synchronous or asynchronous, delayed, or immediate. Synchronous events are synchronized within, but not across, event queues. In some examples, the following event types are supported by the message handling service architecture 300:

TABLE 2
EVENT TYPES

| EVENT TYPE | PLATFORM RESPONSE TO EVENT |
|---|---|
| Asynchronous | Scheduled on a new thread independently of any other |
| | events as soon as the delay has expired. |
| Synchronous | Scheduled to run only if an event of the same type is not |
| First Only | currently scheduled to run sooner on the same queue. |
| Synchronous | Scheduled to run only if an event of the same type is not |
| Last Only | currently scheduled to run later on the same queue. |
| | Earlier events of the same type are cancelled if they |
| | have not yet run. |
| Synchronous | All scheduled events of this type on the queue will be run |
| | in order. Earlier events must complete before new |
| | events are run. |
| Interval First | Only one event of this type will be allowed to run |
| | during the specified interval. Newly scheduled events |
| | will be discarded if an event is already scheduled, or |
| | delayed if necessary if a prior event ran within the |
| | interval. Events are run asynchronously. |
| Interval Last | Only one event of this type will be allowed to run during |
| | the specified interval. Newly scheduled events will |
| | replace existing events that have not yet run. Events |
| | are run asynchronously. |
| Custom | A developer provided event type that allows more |
| | complex scheduling rules than those provided above. |

A virtual area specification can import a standard set of messages and handlers (e.g., messages and handlers in a library that is provided by Social Communications Company as part of an Area Development Kit) and/or define new messages and handlers. An application typically can reference a core set of handlers and messages that are defined at the platform level (e.g., transport messages, such as publish and subscribe and core platform messages, such as RdsState messages). An application can extend the handling of platform messages by defining secondary handlers that get called after the platform handler has run but the platform handler will always run first. The message router uses the Channel ID to identify the virtual area application and the sending network node, and uses the Message ID to identify the proper handler within the identified virtual area application. In some examples, a channel may be published within a single zone, in which case a message received on that channel originated within the context of that zone. Examples of such channels are individual chat channels in a zone that are published when a communicant enters the zone. Since these channels relate only to that zone, a given handler can determine the publishing zone from the Channel ID.

The network transports 302 include a stream transport service and UDP, HTTP, and TCP network transport protocols 320, 322, 324 for interfacing the application layer with the network layer over serial UDP, HTTP, and TCP data streams. The network transports 302 manage movement of data through the network in accordance with one or more protocols (e.g., Internet Protocol (IP), Internet Control Message Protocol (ICMP), and Internet Group Management Protocol (IGMP)).

The router 304 includes a stream transport service, a STRAW protocol 330, a common transport 332, a message router 334, and an event router 336. The stream transport service manages sessions on respective transport streams that carry data between respective nodes as definition records over STRAW sockets in accordance with the STRAW protocol described above. The stream transport service exchanges messages with the message router 334 and the event router 338 through the common transport, which parses each incoming message to determine the node that transmitted the message, the virtual area application that is associated with the message, and the message type of the message. In some examples, when a STRAW message is received by the common transport, the common transport 332 uses the ChannelID in the STRAW header to uniquely identify the sending network node and the destination virtual area application. The enclosed SODA message is enqueued on a channel queue 328 for routing by the message router 334. The common transport 332 passes events to the event router 336 for routing.

The message router 334 routes the messages in the channel queues to one or more of the application message handlers 308 or one or more of the platform message handlers 310 depending on the message type. In this process, the message router 334 calls one or more application or platform message handler objects that are designated in the virtual area application or the platform rules for handling the message and passes the message to the instantiated message handlers 308, 310. In some examples, when the SODA message is processed, the appropriate handlers for the message and application are called, as defined by the virtual area specification. Message handlers are dynamically bound at runtime—the message router looks up the name specified at in the virtual area specification through a naming directory interface (e.g., the Java Naming and Directory Interface, or JNDI). A primary handler and any number of secondary handlers can be defined in the virtual area specification. Messages are processed one at a time, either in the order received or in packet number order, depending on the channel attributes.

Depending on the message type, the application and platform message handlers 308, 310 may call one or more of the event schedulers 306 to schedule an event or may call one or more of the zone managers 316 to act on the message (e.g., apply application rules 340 to a proposed client state change 342). The application of the zone manages 316 may result in a variety of different actions by the platform. For example, a zone manager may apply validated state changes to the model of the virtual area, send outbound messages to one or more of network nodes (e.g., informing a client that a proposed state change was invalid and not made), or schedule an event through the event schedulers 306.

The event router 336 routes the incoming events to the event schedulers 306 that are designated in the platform rules for scheduling the events. In this process, the event router 336 calls the designated event scheduler objects and passes the events to the instantiated event schedulers 306. The event schedulers 306 schedule the events and, based on the schedule, route the events either to the application event handlers 312 or the platform event handlers 314 depending on the message type. In this process, the event scheduler 306 calls one or more application or platform event handler objects that are designated in the virtual area application or the platform rules for handling the event and passes the event to the instantiated event handlers 312, 314.

In addition, to responding to calls from the application and platform message and event handlers 308-314 and the zone managers 316, the event schedulers also may be called in response to external events 344.

As explained above, RDS is the real-time data stream that is used to communicate state changes between the client and the server. An RDS state message is an extensible message from a client network node that communicates a proposed state change. Examples of the types of state changes that are supported by the message handling service architecture 300 include the following:
Zone Presence
Location within a zone (X,Y,Z or seat number)
Media (e.g., audio or video) Source Zones
Media (e.g., audio or video) Sink Zones
Screen Sharing Source Zones
PSTN Call State (for PSTN guest clients as described in U.S. patent application Ser. No. 13/165,729, filed Jun. 21, 2011)

In some examples, RDS data streams drive many changes within a virtual area application. When an RDS message is received from a client network node, the message handling service architecture 300 passes it to each designated zone manager in turn for validation of the proposed state. Once the change has been validated, it is again passed to each zone manager for processing. RDS State change processing typically triggers changes within a virtual area.

The zone managers 316 are platform services that enforce and apply rules (e.g., platform rules and application rules). Platform rules typically apply to all virtual area applications. Application rules are optionally specified in the virtual area specification. In some examples, a zone manager acts on one or more of the following types of client actions: application entry or exit; channel subscription; and RDS state changes.

When a network node first enters an application it sends a SodaAreaEnter message. This message triggers a call to the on AreaEnter method for each of the zone managers configured in the virtual area specification. The AreaEnter message is handled by the AreaEnter message handler. This message handler looks up a list of zone managers that have entry governance rules and has two major processing steps: checking validation rules, which involves applying all of the zone managers to determine whether or not the communicant can enter the virtual area given the platform and application rules; and reapplying the zone managers to the platform and governance rules. In some examples, after entry has been allowed, a SessionZoneManager provides the new session with session level information about potential peers currently in the area and publishes any applicable channels to the new session. An RdsZoneManager also ensures that there is room in the area for the member to enter and applies rules to place the user in the default entry zone (e.g., a virtual lobby). Typical rules on entry also include granting of capabilities to the client and updating client and application state to reflect a new client.

Receipt of a SodaAreaExit message triggers a call to the corresponding on AreaExit method. The AreaExit message is handled by the AreaExit message handler. It calls the same set of zone managers as AreaEnter to notify them that the user is exiting. In some examples, the SessionZoneManager triggers an asynchronous event that cleans up the session and notifies all other users that the client has exited.

When a zone manager is defined in the virtual area specification, one or more managed channels are specified. When a client network node subscribes to one of these channels by sending a StrawSubscribe message to the server network node, an on ChannelSubscribe method is called for the managing zone manager. The Subscribe message is handled by the Subscribe message handler. A zone manager verifies that the communicant has the appropriate capability to subscribe to the channel and applies governance rules if it is permitted. These rules may cause state and configuration messages to be sent on the newly subscribed channel that communicate the current global state of the virtual area as it relates to the specific service the zone manager supports. Typical zone manager rules on channel subscription are to send a full update of the service information managed by the zone manager to the subscribing client. For example, subscription to the RDS Control channel causes the RDS Zone Manager to send a full update of the RDS state for all other clients in the application to the subscribing client. Subscription to the Session Control channel causes the Session Zone Manager to publish all channels for the zones in which the subscribing client is present. The SessionZoneManager configures communication parameters (maximum packet size for example) and sets up a reporting interval for the client to send statistics about the session. A DefinitionsZoneManager triggers a series of asynchronous events that send messages to the client containing rendering information about the area, information about the other members (e.g., profile data), state information about the area (whether doors are opened or closed, for example), capabilities and features available (whether phone out is enabled, for example), and customization data (e.g., room names). The RdsZoneManager communicates state information about other members in the area by sending their current RdsState in its entirety. RdsState includes, for example, information about which zones a communicant is in, the location within that zone, which zones the communicant is listening in, which zones the communicant is speaking in, and which zones the communicant is screen sharing or viewing in.

When a client network node unsubscribes to one of these channels by sending a StrawUnsubscribe message to the server network node, an on ChannelUnsubscribe method is called. The Unsubscribe message is handled by an Unsubscribe message handler. It functions essentially the same as the Subscribe message except that instead of setting up the channel, the zone managers perform cleanup operations associated with unsubscribing to the channel.

When an RDS state change is received from a client (SodaRDSState message), each zone manager is called in turn to validate the change. The RdsState message is handled by the RdsState message handler. RdsState typically is the primary driver of peer to peer related changes within the system. In some examples, RdsState messages always are sent as an idempotent message that includes all the state information. That is, the RdsState message includes an entire proposed state when sent from a client network node or an entire definitive state when sent from the server network node. For example, if a communicant is in the lobby in a specific position, has his headset on (is listening) in the lobby, has his microphone off (is not broadcasting), and is not screen sharing or viewing, the RdsState message sent from the client network node includes all of this information. In these examples, the RdsState message is not sent as a transitional message (e.g., it would not say toggle the microphone instead it would specify the desired end state), nor does it have a partial state (e.g., it would not contain just the microphone change). Such an approach ensures that the state is consistent between the client and server and that nothing unexpected happens.

When the RdsState message is received by the server network node, it is validated by all the zone managers. For example, the RdsZoneManager ensures that the state defined in the RdsState message is internally consistent and that the user has the appropriate capabilities do make the changes proposed. The ScreenShareZoneManager ensures that the client is present in a screen sharing zone and ensures that there is only a single client hosting a document. The MediaZoneManager ensures that the audio sources, sinks and zones of presence are consistent with the rules of the application. For example, a virtual area specification may specify that a client must be present in any zone in which they are sourcing or sinking audio. In some examples, these rules are applied on State Change. In other examples, an audio configuration event is scheduled both on RDS change and on audio control channel subscription.

Once validated, each zone manager is called again to process the change and apply the application rules. In this regard, the SessionZoneManager will publish any channels that have not previously been published and have configured to be published on zone entry. The RdsZoneManager will communicate the new state to all other users who have the capability to see it and will grant any capabilities that are granted upon entry to the new zone(s) and revoke any that are revoked on exit from the old zone(s). For example, on entry to an office, a user may be granted the capability to open or close the door or to make a phone call using the office phone. The MediaZoneManager triggers an asynchronous event that resolves peer to peer audio state based on the rules configured for the application. For example, a rule may state that if a communicant has her microphone on in a zone, configure peer to peer audio with any communicants who have their headsets on in the same zone. For zones that have been exited, MediaZoneManager may remove the P2P audio session. The ChatZoneManager publishes a unique chat channel for the newly entered zone (if the application rules so specify). The ScreenShareZoneManager sets up screen sharing based on state within screen sharing zones. In this process, the ScreenShareZoneManager establishes P2P sessions as necessary and configures the clients to send and receive screen share content based on similar rules to audio. If a communicant is a sharer in the Screen Share zone and another communicant is a viewer, a Screen Share stream from the sharer to the viewer will be established. On exit, the p2p sessions are removed.

The virtual area platform enables a wide variety of highly customizable virtual area applications to be created. For example, the virtual area platform enables virtual area based communication services that integrate various channels and styles of communication, including web sites, voice, chat, and various forms of video (e.g., a video feed generated by a running application or a video feed of a virtual area and activities occurring in the virtual area).

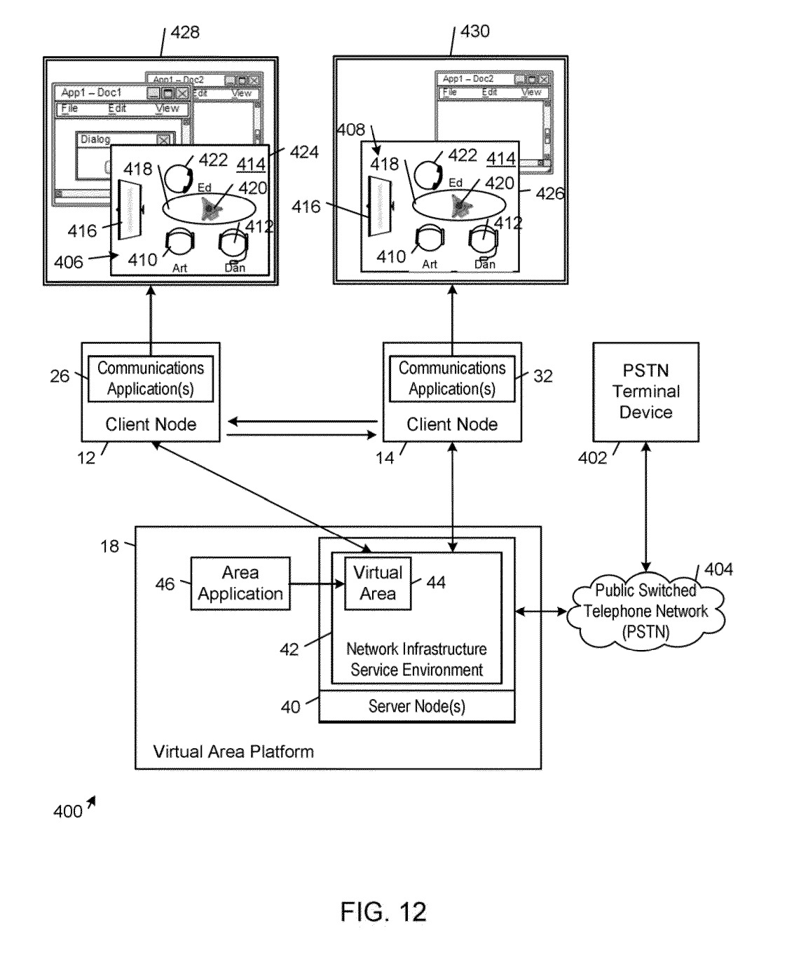

FIG. 12 shows an example 400 of the network communications environment 10 that additionally includes a PSTN device 402 that is connected to the client network nodes 12, 14, and is connected to the server node 40 through a PSTN 404. The PSTN terminal device 402 is any device that communicates over the PSTN 404, including mobile devices (e.g., mobile phones and portable computing devices, such as tablet and notebook computers) and fixed-line telephones. In this example, the server network node 40 typically includes components (e.g., a Voice eXstensible Markup Language (VXML) interpreter, a speech recognition engine, a text to speech synthesizer, and a Dual Tone Multi-Frequency (DTMF) decoder) that enable a user of the PSTN terminal device 402 to connect to the virtual area applications 46 through one or more PSTN modalities.

In the illustrated embodiment, the communications applications 26, 32 operating on the first and second client network nodes 12, 14 present respective spatial visualizations 406, 408 (or views) of the virtual area 44 in accordance with data received from the virtual area platform 18. The communications applications 26, 32 also provide respective interfaces for receiving commands from the communicants and providing a spatial interface that enhances the realtime communications between the communicants. The spatial visualizations 406, 408 include respective graphical representations 410, 412 (referred to herein as “avatars” or “sprites”) of the client communicants in spatial relation to a graphical representation 414 of a virtual area. The spatial visualizations 406, 408 also may include other objects. Examples of such props include a view screen object 416 for application sharing, a table object 418 for file sharing, and a conferencing object 420 for initiating telephone calls to PSTN terminal devices. The user of the PSTN terminal device 402 also is represented in the virtual areas by a respective avatar 422. In some examples, the avatars 410, 412, 422 are moved about the virtual areas 32 based on commands that are input by the communicants at their respective network nodes 12, 14, 402.

The spatial visualizations 406, 408 on the client nodes 12, 14 are presented in respective windows 424, 426 that are generated by the virtual area enabled communications applications 26, 32. The communication application windows 424, 426 typically are displayed on respective “desktops” or other system-defined base windows 428, 430 on the display hardware of the client nodes 12, 14.

The server network node 40 also manages connection of the PSTN terminal device 402 to the virtual area 44 so that a PSTN terminal device user can participate in virtual area based communications (e.g., communicate with one or more other communicants who are in the virtual area 44, or retrieve data from or store data in the virtual area 44), where the methods described in U.S. patent application Ser. No. 13/165,729, filed Jun. 21, 2011, are carried out by an example of the message handling service architectures described above according to an example of the virtual area application 46.

In other examples, the message handling service architectures are driven by a state and a configuration that defines what to do when a state change occurs. In some of these examples, a virtual area specification may provide definitions for identifying a target state change in a remote system and acting on the target state change when it occurs. In one such example, a virtual area application includes one or more definitions for responding to alarm messages transmitted by one or more external network nodes (e.g., a network operations server system). For example, an alarm message may be transmitted by an external node to report an incident (e.g., a network node has gone offline). The virtual area application also defines an event handler that responds to receipt of an alarm message by dynamically creating a virtual response room in the virtual area, passing to the event scheduler events for transmitting invitation messages inviting one or more members of a response team to enter the virtual response room, and configuring the virtual response room for the particular incident reported in the alarm message (e.g., automatically associate viewscreen props in the virtual response room with a URL to a network service).

### III. CONCLUSION

Other examples are within the scope of the claims.

1. A method, comprising:
creating a model of a virtual area based on a virtual area specification that defines one or more zones of the virtual area, specifies a message handling protocol for each of one or more message types, specifies validation rules for validating messages of respective message types in connection with respective ones of the one or more zones, and specifies follow-on rules for acting on messages of respective message types;
for each of multiple messages of respective ones of the message types received from respective network nodes in respective sessions associated with respective ones of the one or more zones of the virtual area,
determining the message handling protocol specified in the virtual area specification for the respective message type of the message,
handling the message according to the determined message handling protocol, wherein the handling comprises identifying any validation rules specified in the virtual area specification for validating messages of the respective message type of the message in connection with the respective zone, validating the message against each identified validation rule, and based on validation of the message against all the identified validation rules, identifying any follow-on rules specified in the virtual area specification for acting on messages of the respective message type of the message and acting on the message according each identified follow-on rule; and
managing communications of respective ones of the network nodes in connection with the virtual area based on the model of the virtual area and results of the handling.

2. The method of claim 1, wherein the virtual area specification specifies an area entry message handling protocol for area entry messages and, for an area entry message from a particular one of the network nodes requesting entry into the virtual area,
the determining comprises determining the area entry message handling protocol specified in the virtual area specification, and
the handling comprises handling the area entry message according to the determined area entry message handling protocol, wherein the handling comprises ascertaining one or more changes to state information in a model of the virtual area to reflect entry of the particular network node into the virtual area;
further comprising modifying the model of the virtual area based on the one or more ascertained changes to produce a current model of the virtual area; and
wherein the managing comprises managing communications of respective ones of the network nodes in connection with the virtual area based on the current model of the virtual area.

3. The method of claim 2, wherein:
the ascertaining comprises ascertaining one or more changes to a state attribute of the particular network node in the model of the virtual area to reflect entry of the particular network node into the virtual area; and
the producing comprises making the one or more ascertained changes to the state attribute of the particular network node in the model of the virtual area.

4. The method of claim 2, wherein the virtual area specification specifies one or more follow-on rules for acting on area entry messages that grant one or more respective capabilities permitting one or more actions, behaviors, or states in the virtual area; and responsive to the area entry message transmitted by the particular network node, granting the one or more respective capabilities to the particular network node according to the one or more follow-on rules specified in the virtual area specification for acting on the area entry messages.

5. The method of claim 1, wherein the virtual area specification specifies types of data streams that are communicable between network nodes associated with respective ones of the one or more zones, and the managing comprises managing communication of the specified types of data streams to respective ones of the network nodes based on the model of the virtual area and the results of the handling.

6. The method of claim 1, wherein:
the virtual area specification defines switching rules each comprising a respective instruction for connecting sources of a respective data stream type with sinks of the respective data stream type in terms of associations of the sources and sinks with respective ones of the one or more zones, specifies a handling protocol that is triggered by state changes proposed in subscription messages of respective subscription types; and
for a subscription message of a particular subscription type from a particular one of the network nodes proposing a state change in connection with a particular one of the one or more zones,
the handling comprises handling the subscription message according to the handling protocol triggered by the state change proposed in the subscription message, wherein the handling comprises identifying any validation rules specified in the virtual area specification for validating the proposed state change in connection with the particular zone, validating the proposed state change against each identified validation rule, and based on validation of the proposed state change against all the identified validation rules, identifying any follow-on rules specified in the virtual area specification for acting on proposed state change and determining from the identified follow-on rules information enabling delivery of data streams associated with the particular subscription type to the particular network node according to the switching rules;
wherein the managing comprises sending the determined information to one or more of the network nodes.

7. The method of claim 6, wherein validating the state change proposed in the subscription message comprises verifying that the particular subscription type previously was published to the particular node.

8. The method of claim 6, wherein validating the state change proposed in the subscription message comprises verifying that the particular network node has a capability permitting subscription to the particular subscription type in the particular zone.

9. The method of claim 6, wherein the particular subscription type is state data, and the subscription information comprises one or more data streams corresponding to the particular subscription type.

10. The method of claim 6, wherein the particular data stream type corresponds to media content, and the subscription information comprises instructions for other network nodes to publish media content data streams associated with the particular subscription type in each of the one or more zones to which a respective presence attribute of the particular network node is linked.

11. The method of claim 1, wherein
the virtual area specification specifies a state message handling protocol for state messages, specifies validation rules for validating state messages in connection with respective ones of the one or more zones, and specifies follow-on rules for acting on state messages, and
for a state message comprising a change in an attribute of a particular one of the network nodes in connection with particular ones of the one or more zones,
the determining comprises determining the state message handling protocol specified in the virtual area specification, and
the handling comprises handling the state message according to the determined state message handling protocol, wherein the handling comprises identifying any validation rules specified in the virtual area specification for validating state messages in connection with the particular ones of the one or more zone, validating the subscription message against each identified validation rule, and based on validation of the state message against all the identified validation rules, identifying any follow-on rules specified in the virtual area specification for acting on the state message and ascertaining from the identified follow-on rules one or more changes to the model of the virtual area that reflect the change in the attribute of the particular network node;
further comprising modifying the model of the virtual area based on the one or more ascertained changes to produce a current model of the virtual area; and
wherein the managing comprises managing communications of respective ones of the network nodes in connection with the virtual area based on the current model of the virtual area.

12. The method of claim 11, further comprising, based on validation of the state message against all the identified validation rules, sending to the particular network node a notification that the attribute change was made.

13. The method of claim 11, wherein the ascertaining comprises determining that additional modification of one or more of the attributes of the particular network node is required by respective rules specified in the virtual area specification as a result of the attribute change; and
further comprising changing state information in the model of the virtual area to reflect the determined additional modification of the one or more attributes of the particular network node, and sending to the particular network node a notification that the attribute change and the determined additional modification of the one or more attributes of the particular network node were made.

14. The method of claim 11, wherein the handling comprises, based on failure to validate the state message against all the identified validation rules, determining a current state of the particular node that reflects a revocation of the attribute change in the state message; and
further comprising sending the determined current state to the particular network node.

15. The method of claim 11, wherein:
the virtual area specification defines switching rules each defining a respective instruction for connecting sources of a respective data stream type with sinks of the respective data stream type in terms of associations of the sources and sinks with respective ones of the one or more zones;
based on validation of the state message against all the identified validation rules, the determining comprises determining from the identified follow-on rules information enabling delivery of data streams between sources and sinks associated with the particular ones of the one or more zones according to the switching rules, and determining subscription information for one or more data stream types that enable the particular network node to establish connections according to the switching rules; and
the managing comprises sending the determined information to one or more of the network nodes associated with the particular ones of the one or more zones.

16. The method of claim 15, wherein:
the virtual area specification specifies one or more attribute consistency rules that impose respective conditions on changes to attributes of network nodes in respective sessions associated with the virtual area;
the state message comprises a change of a media control attribute of the particular network node; and
the validating comprises verifying that allowance of the media control attribute change would result in connections between media sources and media sinks of network nodes in respective sessions associated with the virtual area that are consistent with the one or more attribute consistency rules specified in the virtual area specification.

17. The method of claim 16, wherein the verifying comprises verifying that that allowance of the media attribute change would result in the particular network node having a respective presence attribute linked to each zone in which the particular network node is sourcing or sinking a respective realtime media data stream.

18. The method of claim 16, wherein the state change message comprises a change of an application sharing attribute of the particular network node, and the verifying comprises verifying that allowance of the application sharing attribute change would result in the particular network node having a presence attribute linked to a respective one of the zones from which application sharing data is being sourced.

19. The method of claim 16, wherein the state change message comprises a change of an application sharing attribute of the particular network node, and the verifying comprises verifying that after the requested application sharing attribute change there would be only a single network node hosting a particular application sharing data stream sourced from a respective one of the zones.

20. The method of claim 16, wherein the verifying comprises verifying that allowance of the attribute change would result in consistency of the attribute states of all the network nodes in respective sessions associated with the virtual area.

21. The method of claim 16, wherein the attribute change corresponds to linking a presence attribute of the particular node to a particular one of the one or more zones, and the verifying comprises verifying that the particular network node has a capability that permits linking of the presence attribute of the particular node to the particular zone.

22. The method of claim 11, wherein the virtual area specification specifies one or more visibility rules controlling access to respective state information in respective ones of the one or more zones; and further comprising propagating the ascertained changes to the model of the virtual area to each of the network nodes that are in respective sessions associated with the virtual area and are permitted to receive the ascertained changes according to the one or more visibility rules.

23. Apparatus, comprising a memory storing processor-readable instructions; and a processor coupled to the memory, operable to execute the instructions, and based at least in part on the execution of the instructions operable to perform operations comprising:
creating a model of a virtual area based on a virtual area specification that defines one or more zones of the virtual area, specifies a message handling protocol for each of one or more message types, specifies validation rules for validating messages of respective message types in connection with respective ones of the one or more zones, and specifies follow-on rules for acting on messages of respective message types;
for each of multiple messages of respective ones of the message types received from respective network nodes in respective sessions associated with respective ones of the one or more zones of the virtual area,
determining the message handling protocol specified in the virtual area specification for the respective message type of the message,
handling the message according to the determined message handling protocol, wherein the handling comprises identifying any validation rules specified in the virtual area specification for validating messages of the respective message type of the message in connection with the respective zone, validating the message against each identified validation rule, and based on validation of the message against all the identified validation rules, identifying any follow-on rules specified in the virtual area specification for acting on messages of the respective message type of the message and acting on the message according each identified follow-on rule; and
managing communications of respective ones of the network nodes in connection with the virtual area based on the model of the virtual area and results of the handling.

24. At least one computer-readable medium having processor-readable program code embodied therein, the processor-readable program code adapted to be executed by a processor to perform operations comprising:
creating a model of a virtual area based on a virtual area specification that defines one or more zones of the virtual area, specifies a message handling protocol for each of one or more message types, specifies validation rules for validating messages of respective message types in connection with respective ones of the one or more zones, and specifies follow-on rules for acting on messages of respective message types;
for each of multiple messages of respective ones of the message types received from respective network nodes in respective sessions associated with respective ones of the one or more zones of the virtual area,
determining the message handling protocol specified in the virtual area specification for the respective message type of the message,
handling the message according to the determined message handling protocol, wherein the handling comprises identifying any validation rules specified in the virtual area specification for validating messages of the respective message type of the message in connection with the respective zone, validating the message against each identified validation rule, and based on validation of the message against all the identified validation rules, identifying any follow-on rules specified in the virtual area specification for acting on messages of the respective message type of the message and acting on the message according each identified follow-on rule; and
managing communications of respective ones of the network nodes in connection with the virtual area based on the model of the virtual area and results of the handling.

25-53. (canceled)
